(19) United States
(12) Patent Application Publication
(10) Pub. No.: US 2013/0332470 A1
(43) Pub. Date: Dec. 12, 2013

(54) INFORMATION PROCESSING APPARATUS, INFORMATION PROCESSING METHOD, AND PROGRAM

(71) Applicant: SONY CORPORATION, Tokyo (JP)

(72) Inventor: Katsu SAITO, Saitama (JP)

(73) Assignee: Sony Corporation, Tokyo (JP)

(21) Appl. No.: 13/859,159

(22) Filed: Apr. 9, 2013

(30) Foreign Application Priority Data
Jun. 12, 2012 (JP) 2012-132877

(51) Int. Cl. G06F 17/30

(52) U.S. Cl. CPC G06F 17/30312
USPC 707/751

(57) ABSTRACT

There is provided an information processing apparatus including a totaling unit gathering information indicating a client type and taste information indicating an evaluation to content and totaling the evaluation to content according to the client type, a vector generating unit generating at least a user taste vector expressing a characteristic of content liked by the user and a client type-based vector expressing the characteristic of content liked by the user on a client-type basis, and a recommending unit recommending content by using at least one of the vectors generated by the vector generating unit and a characteristic vector expressing a characteristic of content and, recommending content to a first-time user who makes use of the service for a first time by using the client type-based vector corresponding to the client type of a client used by the first-time user.

### BACKGROUND

The present disclosure relates to an information processing apparatus, an information processing method, and a program, and in particular to an information processing apparatus, an information processing method, and a program that can be favorably used when recommending content.

In the past, a technology has been proposed where user evaluations to songs are provided to a system, a taste vector is generated for each user, and a song list in keeping with a user's taste is provided based on the similarity between characteristic vectors for each song and the taste vector (see, for example, WO 2011/007631). By using such technology, as the accumulated amount of taste information for each user increases, it becomes possible to expand the taste vector of each user and therefore possible to recommend songs that better match the user's taste.

### SUMMARY

However, with the technology according to WO 2011/007631, it is not possible to generate a taste vector for a user for whom taste information has not been accumulated, such as a first-time user who is using the service for the first time. Accordingly, for such users, a song list is generated and provided using a vector generated from the characteristic vectors of a plurality of popular songs, for example. As a result, a song list that will be acceptable on average to lots of people is provided until taste information of such user is accumulated.

Meanwhile, with such services, it is known from experience that a new user will not be able to experience the advantages of the service from one or two uses where the taste information of the user is yet to be accumulated, and in many cases will simply stop using the service.

Accordingly, the selection of songs recommended at the start of use of the service is important so as to enable the user to experience the advantages of the service and encourage the user to continue to use the service.

Accordingly, the present disclosure aims to improve the user's satisfaction with a service that recommends content such as songs, and in particular to improve the satisfaction of a new user using the service.

According to an embodiment of the present disclosure, there is provided an information processing apparatus including a totaling unit gathering information indicating a client type of a client used by a user who makes use of a service recommending content and taste information indicating an evaluation to content provided by the user and totaling the evaluation to content provided by the user according to the client type, a vector generating unit generating at least a user taste vector expressing a characteristic of content liked by the user and a client type-based vector expressing the characteristic of content liked by the user on a client-type basis, and a recommending unit recommending content by using at least one of the vectors generated by the vector generating unit and a characteristic vector expressing a characteristic of content and, recommending content to a first-time user who makes use of the service for a first time by using the client type-based vector corresponding to the client type of a client used by the first-time user.

The totaling unit may further gather information showing a region to which a user belongs and may total an evaluation to content given by the user on a region basis. The vector generating unit may further generate a region-based vector expressing the characteristic of content liked by the user on a region basis. The recommending unit may recommend content to the first-time user by further using the region-based vector corresponding a region to which the first-time user belongs.

The totaling unit may further gather information showing an age of a user and may total an evaluation to content by the user on an age basis or on an age bracket basis. The vector generating unit may further generate an age-based vector expressing the characteristic of content liked by the user on an age basis or on an age-bracket basis. The recommending unit may recommend content to the first-time user by further using the age-based vector corresponding to an age of the first-time user.

The recommending unit may recommend content by alternately using a plurality of types of vectors generated by the vector generating unit.

The vector generating unit may be operable, when a user provides a positive evaluation to content, to generate a priority vector expressing a characteristic of the content or a characteristic of an artist of the content. The recommending unit may recommend content to the user by preferentially using the priority vector.

The recommending unit may reduce a ratio at which the priority vector is used with an elapse of time since the user has provided the positive evaluation to the content.

As a user has a larger amount of the taste information accumulated, the recommending unit may increase a ratio at which the user taste vector of the user is used.

The recommending unit may recommend content to a user by preferentially using a vector that has been used with a high frequency or at a high ratio for recommending content to which the user has provided a positive evaluation.

The recommending unit may recommend content by using a vector produced by combining a plurality of types of vector generated by the vector generating unit.

As a user has a larger amount of the taste information accumulated, the recommending unit may increase a ratio at which the user taste vector of the user is combined.

The information processing apparatus may further include a situation analyzing unit analyzing, based on position information transmitted from a client, a situation of a user using the client. The totaling unit may total an evaluation to content by the user in the situation. The vector generating unit may further generate a situation vector expressing the characteristic of content liked by the user on a situation basis.

According to an embodiment of the present disclosure, there is provided an information processing method carried out by an information processing apparatus providing a service that recommends content, the method including gathering information indicating a client type of a client used by a user who makes use of the service and taste information indicating an evaluation to content provided by the user and totaling the evaluation to content provided by the user according to the client type, generating at least a user taste vector expressing a characteristic of content liked by the user and a client type-based vector expressing the characteristic of content liked by the user on a client-type basis, and recommending content by using at least one of the vectors generated by the vector generating unit and a characteristic vector expressing a characteristic of content and, recommending content to a first-time user who makes use of the service for a first time by using the client type-based vector corresponding to the client type of a client used by the first-time user.

According to an embodiment of the present disclosure, there is provided a program for causing a computer to execute gathering information indicating a client type of a client used by a user who makes use of a service recommending content and taste information indicating an evaluation to content provided by the user and totaling the evaluation to content by the user according to the client type, generating at least a user taste vector expressing a characteristic of content liked by the user and a client type-based vector expressing the characteristic of content liked by the user on a client-type basis, and recommending content by using at least one of vectors generated by a vector generating unit and a characteristic vector expressing a characteristic of content and, recommending content to a first-time user who makes use of the service for a first time by using the client type-based vector corresponding to the client type of a client used by the first-time user.

According to an aspect of the present disclosure, information indicating a client type of a client used by a user who makes use of a service recommending content and taste information indicating an evaluation to content provided by the user are gathered, evaluations by users of content are totaled for each client type, at least a user taste vector expressing characteristics of content liked by an individual user and a client type-based vector expressing characteristics of content liked by users on a client-type basis are generated, content is recommended using at least one of the generated vectors and a characteristic vector expressing characteristics of content and, for a first-time user who is making use of the service for a first time, content is recommended using the client type-based vector corresponding to the client type of a client used by the first-time user.

According to the embodiments of the present disclosure described above, it is possible to improve a user's satisfaction with a service that recommends content. In particular, according to the embodiments of the present disclosure described above, it is possible to improve the satisfaction of a new user using the service.

### BRIEF DESCRIPTION OF THE DRAWINGS

FIG. 1 is a diagram showing the overall configuration of a content recommendation system according to an embodiment of the present disclosure;

FIG. 2 is a diagram showing the hardware configuration of a server;

FIG. 3 is a diagram showing the hardware configuration of a user apparatus;

FIG. 4 is a perspective view showing the external appearance of a user apparatus;

FIG. 5 is a perspective view showing the external appearance of a user apparatus according to a modification;

FIG. 6 is a functional block diagram of a user apparatus;

FIG. 7 is a functional block diagram of a song distributing server;

FIG. 8 is a diagram schematically showing an example data structure of a user evaluation database;

FIG. 9 is a diagram schematically showing an example data structure of a user attribute-based song evaluation database;

FIG. 10 is a diagram schematically showing an example data structure of a situation-based song evaluation database;

FIG. 11 is a diagram schematically showing an example data structure of a user attribute database;

FIG. 12 is a diagram schematically showing an example data structure of a song information database;

FIG. 13 is a diagram schematically showing an example data structure of a song characteristic database;

FIG. 14 is a diagram schematically showing an example data structure of a song attribute database;

FIG. 15 is a functional block diagram of a recommendation unit;

FIG. 16 is a diagram showing the stored content of an internal ranking storage unit;

FIG. 17 is a flowchart useful in explaining a user evaluation totaling process;

FIG. 18 is a flowchart useful in explaining a default vector generating process;

FIG. 19 is a flowchart useful in explaining a situation vector generating process;

FIG. 20 is a flowchart useful in explaining a song recommendation process;

FIG. 21 is a flowchart useful in explaining a standard vector setting process;

FIG. 22 is a flowchart useful in explaining a recommended song list generating process;

FIG. 23 is a diagram showing an example of a first list; and

FIG. 24 is a flowchart useful in explaining a user evaluation reflecting process.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present disclosure are described in the order indicated below.

### 1. Embodiments

### 2. Modifications

### 1. First Embodiment

### Example Configuration of Content Recommendation System 10

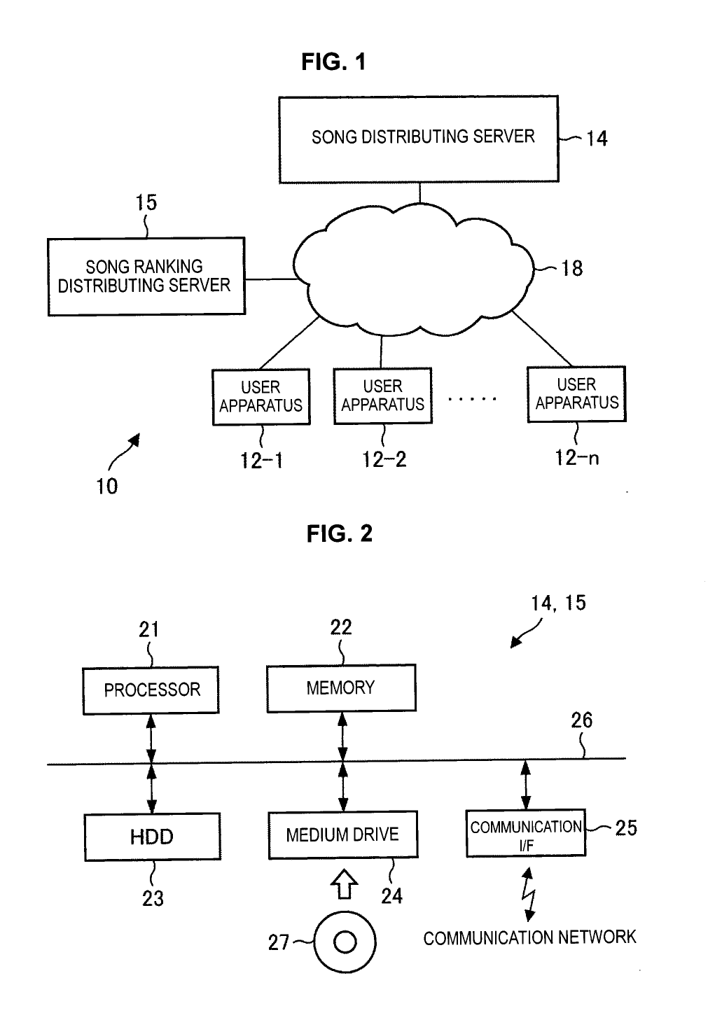

FIG. 1 is a diagram showing the overall configuration of a content recommendation system 10 according to an embodiment of the present disclosure.

The content recommendation system 10 includes a song distributing server 14, a song ranking distributing server 15, and a plurality of user apparatuses 12-1 to 12-n as clients. All of such apparatuses are connected to a communication network 18, such as the Internet, and are capable of data communication with one another.

Note that in the following description, when it is not necessary to distinguish between the user apparatuses 12-1 to 12-n, such apparatuses are collectively referred to as the “user apparatus 12”.

As examples, the user apparatus 12 is constructed of a computer system such as a personal computer, a computer game system, or a home server set up in the home, or a portable computer system, such as a mobile game console, a mobile phone, a smart phone, or a mobile music player. Each user apparatus 12 accesses the song distributing server 14 and receives a list (hereinafter referred to as a “recommended song list”) of songs recommended to the user of that particular user apparatus 12. Each user apparatus 12 also requests the data of a song included in the recommended song list from the song distributing server 14, and receives and reproduces such data.

Meanwhile, the song distributing server 14 is constructed of a computer system or the like, such as a well-known server computer. The song distributing server 14 transmits a list (“recommended song list”) of songs recommended to the user of a particular user apparatus 12 to such user apparatus 12. The song distributing server 14 also transmits data of individual songs in accordance with requests from the respective user apparatuses 12.

As one example, the song ranking distributing server 15 is also constructed of a computer system or the like, such as a well-known server computer. The song ranking distributing server 15 is managed by a different administrator to the song distributing server 14 and transmits song rankings in response to requests from the song distributing server 14.

As one example, such song rankings are regularly issued (for example, every week or every month) on a country-by-country basis for individual music genres such as pop, jazz, and classical, and are stored in association with the issue date and music genre in the song distributing server 14. Note that such rankings may be generated from a variety of viewpoints, and as one example may be based on number of sales, number of downloads, and/or number of views of song-related information (for example, a song description).

### Example Configurations of Song Distributing Server 14 and Song Ranking Distributing Server 15

FIG. 2 is a diagram showing example hardware configurations of the song distributing server 14 and the song ranking distributing server 15.

The song distributing server 14 and/or the song ranking distributing server 15 include a processor 21, a memory 22, a hard disk drive 23, a medium drive 24, and a communication interface (I/F) 25, with such component elements being connected to a bus 26 so as to be capable of exchanging data with each other.

The processor 21 controls the various component elements of the server in accordance with a program stored in the memory 22, the hard disk drive 23, or a computer-readable medium 27.

The memory 22 includes ROM and RAM, for example, with various system programs being stored in the ROM and the RAM mainly being used as a workspace of the processor 21.

The hard disk drive 23 stores a program for distributing songs and/or distributing song rankings and constructs various databases for distributing songs and/or distributing song rankings.

The medium drive 24 is an apparatus that reads data stored on the computer-readable medium 27, which is a CD-ROM, a DVD-RAM, or the like, and/or writes data onto the computer-readable medium 27.

The communication interface 25 controls data communication via the communication network 18 with another computer system such as a user apparatus 12.

### Example Configuration of User Apparatus 12

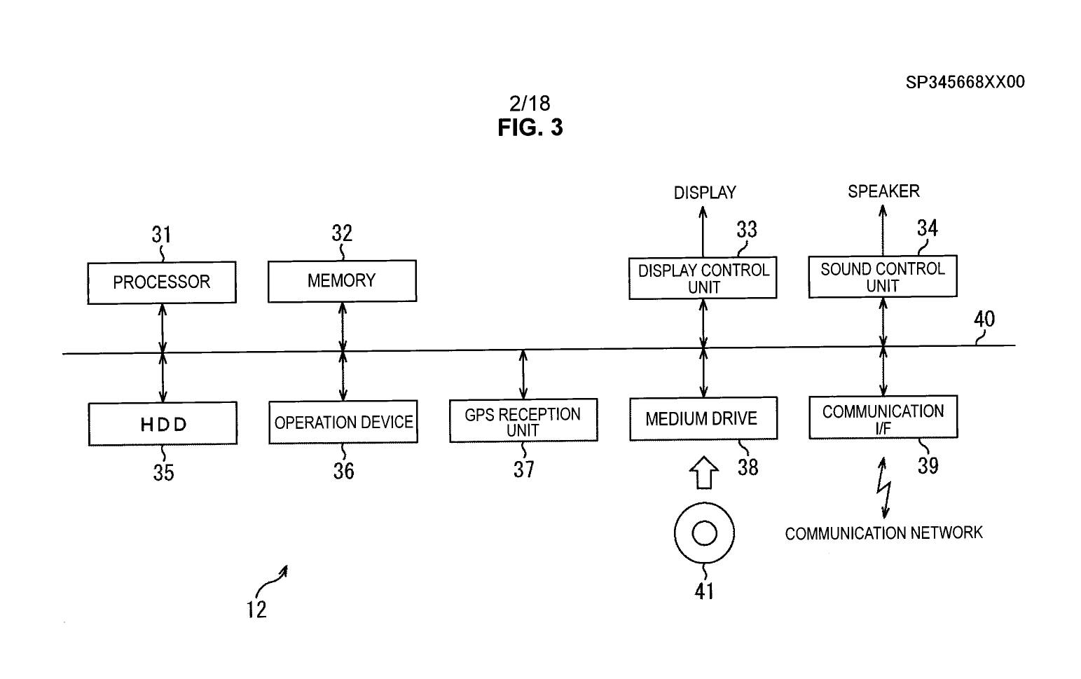

FIG. 3 is a diagram showing an example hardware configuration of the user apparatus 12.

The user apparatus 12 includes a processor 31, a memory 32, a display control unit 33, a sound control unit 34, a hard disk drive 35, an operation device 36, a GPS (Global Positioning System) reception unit 37, a medium drive 38, and a communication interface (UF) 39, with such component elements being connected to a bus 40 so as to be capable of exchanging data with each other.

The processor 31 controls the various component elements of the user apparatus 12 in accordance with a program stored in the memory 32, the hard disk drive 35, or a computer-readable medium 41.

The memory 32 includes ROM and RAM, for example, with various system programs being stored in the ROM and the RAM mainly being used as a workspace of the processor 31.

The display control unit 33 includes a video memory, converts images drawn in the video memory by the processor 31 to a video signal, and outputs the video signal to a display to have the images displayed.

The sound control unit 34 includes a sound buffer and converts sound data stored in the sound buffer by the processor 31 to an analog audio signal and outputs the analog audio signal to speakers to have sound outputted.

The hard disk drive 35 stores various programs such as a song reproduction program and constructs various databases.

The operation device 36 is used for example by the user to give various instructions to the user apparatus 12 and to input data, and as examples is constructed of a keyboard, a pointing device such as a mouse, or a game pad.

The GPS reception unit 37 receives electromagnetic waves from positioning satellites and measures the present position of the user apparatus 12. The GPS reception unit 37 supplies a measurement result for the present position of the user apparatus 12 to the processor 31 and/or transmits, via the communication interface 39, to another computer system such as the song distributing server 14.

The medium drive 38 is an apparatus that reads data stored on a computer readable medium 41 such as a CD-ROM or a DVD-RAM and/or writes data on the medium.

The communication interface 39 controls data communication via the communication network 18 with another computer system such as the song distributing server 14.

Note that the hardware configuration of the user apparatus 12 shown in the drawings is merely one example, with it being possible to omit parts of the configuration or to add other component elements. As one example, if the user apparatus 12 is configured by a stationary apparatus such as a desktop personal computer, it is possible to omit the GPS reception unit 37.

### Specific Example of User Apparatus 12

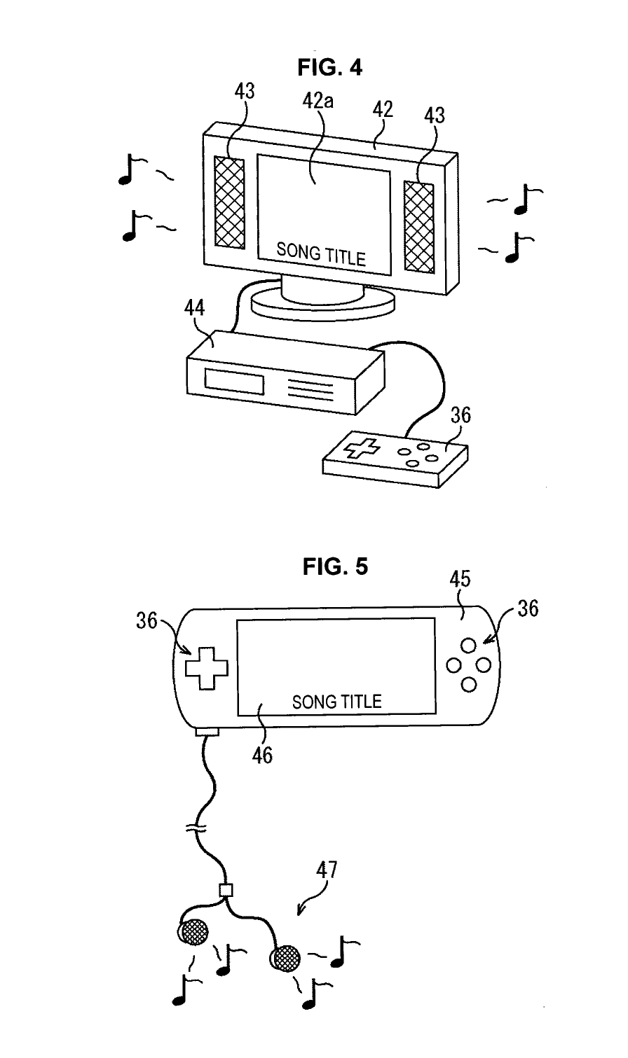

The user apparatus 12 can be realized in a variety of forms, and one example configuration shown in FIG. 4 is a home game console that operates off a domestic power supply.

In this case, the hardware elements shown in FIG. 3 are housed in a case 44 and a display 42a and speakers 43 of a television set 42 that is separate to the case 44 are used as the display and speakers. The operation device 36 is also provided separately to the case 44.

As an alternative, the user apparatus 12 can be configured as shown in FIG. 5 as a portable all-in-one game console that operates off batteries.

In this case, the hardware elements shown in FIG. 3 are housed in a case 45 and a flat panel display 46 provided on the surface of the case 45 is used as the display. The operation device 36 is also provided on the surface of the case 45 and as one example is disposed on the left and right of the flat panel display 46 As the speakers, speakers, not shown, incorporated in the case 45 may be used, as may be stereo headphones 47 that are separate to the case 45.

### Example of Functional Configuration of User Apparatus 12

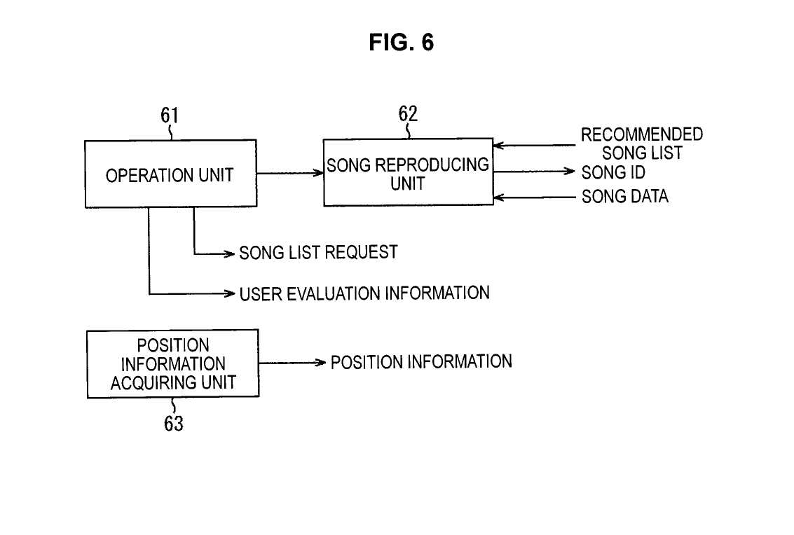

Here, the functional configuration of a user apparatus 12 will be described. FIG. 6 is a functional block diagram of the user apparatus 12.

The user apparatus 12 is functionally configured from an operation unit 61, a song reproduction unit 62, and a position information acquiring unit 63. As one example, such component elements are realized by the user apparatus 12 executing a program.

The operation unit 61 is configured so as to be centered on the operation device 36 and when a specified request operation has been performed for the operation device 36, a request (hereinafter “song list request”) for a recommended song list is transmitted via the communication interface 39 to the song distributing server 14. This song list request includes a user ID that is identification information for the user, song attributes (hereinafter “indicated attributes”) a client type ID that is identification information for the type of the user apparatus 12, and position information of the user apparatus 12.

Note that the criteria for sorting the types (hereinafter referred to as “client types”) of the user apparatuses 12 can be set arbitrarily. As one example, it is possible to sort according to the type and form of the user apparatus 12 such as “personal computer” or “mobile game console”, or to sort more precisely into specific models.

If the user has inputted an evaluation for a song using the operation device 36, the operation unit 61 transmits user evaluation information including a song ID that is identification information for the song being evaluated, the user ID of the user making the evaluation, the client type ID and position information of the user apparatus 12, and the inputted evaluation via the communication interface 39. As examples, it is possible for the user to provide a positive evaluation (for example, “like”), a negative evaluation (for example, “dislike”) or an evaluation value (for example, evaluation on five levels or a points score) to each song.

The operation unit 61 also determines a user evaluation to a song based on a user operation (as examples, skipping or stopping) carried out on the operation device 36 during reproduction of the song and the reproduced state of the song (as one example, whether the song was reproduced to the end). The operation unit 61 then transmits user evaluation information including the determined evaluation via the communication interface 39.

In addition, if a user operation has been carried out for the operation device 36, the operation unit 61 may notify the song reproducing unit 62 of such operation as necessary.

The song reproducing unit 62 receives the recommended song list transmitted from the song distributing server 14 via the communication network 18 and the communication interface 39. In addition, the song reproducing unit 62 transmits the song ID of each song included in the recommended song list in order of the list via the communication interface 39 to the song distributing server 14. The song reproducing unit 62 receives song data transmitted from the song distributing server 14 in reply to transmission of a song ID via the communication network 18 and the communication interface 39 and reproduces the song data using the sound control unit 34. At this time, as shown in FIGS. 4 and 5, the song reproducing unit 62 displays the title of the song included in the song data on the display. The song reproducing unit 62 also controls reproduction of the song data in accordance with user operations of the operation device 36.

The position information acquiring unit 63 is constructed so as to be centered on the GPS reception unit 37, measures the present position of the user apparatus 12, and transmits the measurement result for the present position via the communication interface 39 to the song distributing server 14.

### Example of Functional Configuration of Song Distributing Server 14

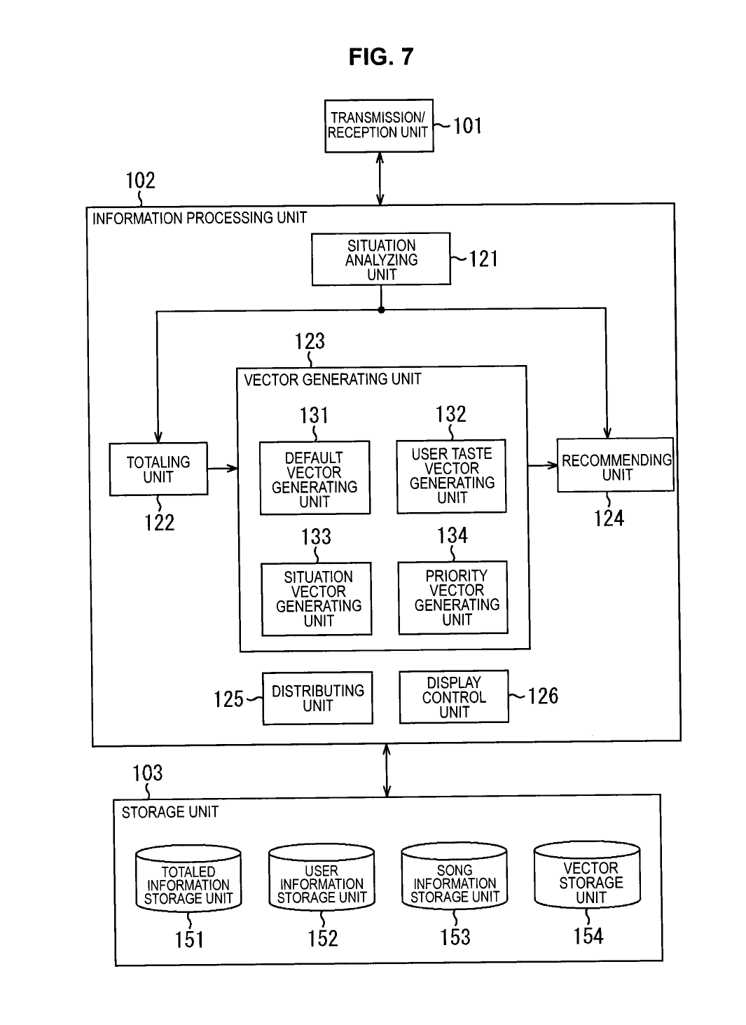

Next, the functional configuration of the song distributing server 14 will be described. FIG. 7 is a functional block diagram of the song distributing server 14.

The song distributing server 14 is functionally configured from a transmission/reception unit 101, an information processing unit 102, and a storage unit 103.

The information processing unit 102 carries out processing relating to the recommending and distribution of songs and the like and includes a situation analyzing unit 121, a totaling unit 122, a vector generating unit 123, a recommending unit 124, a distributing unit 125, and a display control unit 126.

The vector generating unit 123 carries out the generation of various types of vectors to be used when recommending songs and includes a default vector generating unit 131, a user taste vector generating unit 132, a situation vector generating unit 133, and a priority vector generating unit 134.

The storage unit 103 includes a totaled information storage unit 151, a user information storage unit 152, a song information storage unit 153, and a vector storage unit 154.

Such functional elements are realized by a program being executed in the song distributing server 14.

Also, the various units of the transmission/reception unit 101 and the information processing unit 102 are capable of accessing one another. In addition, the various units of the information processing unit 102 are capable of accessing the various units of the storage unit 103.

The transmission/reception unit 101 is configured so as to be centered on the communication interface 25 and carries out data communication via the communication network 18 with another computer system such as a user apparatus 12. The transmission/reception unit 101 supplies received data to the various units of the song distributing server 14 and transmits data acquired from the various units of the song distributing server 14 to another computer system.

As one example, the transmission/reception unit 101 receives user evaluation information transmitted from each user apparatus 12. The transmission/reception unit 101 then notifies the situation analyzing unit 121 of the position information of the user apparatus 12 included in the user evaluation information and requests analysis of the situation. The transmission/reception unit 101 also supplies the user evaluation information to the totaling unit 122 and requests updating of the results of totaling. In addition, the transmission/reception unit 101 notifies the priority vector generating unit 134 of the song ID included in the user evaluation information and requests generation of a priority vector. The transmission/reception unit 101 also receives song rankings from the song ranking distributing server 15 and supplies such song rankings to the recommending unit 124.

In addition, the transmission/reception unit 101 receives a song list request transmitted from each user apparatus 12. The transmission/reception unit 101 then notifies the user taste vector generating unit 132 of the user ID included in the song list request and requests generation of a user taste vector. The transmission/reception unit 101 also notifies the situation analyzing unit 121 of the position information of the user apparatus 12 included in the song list request and requests analysis of the situation. In addition, the transmission/reception unit 101 notifies the recommending unit 124 of the user ID, client type ID, and indicated attributes included in the song list request and requests generation of a recommended song list.

The transmission/reception unit 101 also notifies the totaling unit 122 of the song ID included in the song list request, the user ID to which the recommended song list is to be sent, and the client type ID of the user apparatus 12 to which the recommended song list is to be sent.

The transmission/reception unit 101 receives a song ID transmitted from a user apparatus 12 and supplies such song ID to the distributing unit 125. The transmission/reception unit 101 then acquires song data corresponding to the song ID received from the user apparatus 12 from the distributing unit 125 and transmits the song data to the user apparatus 12 that issued the request.

The situation analyzing unit 121 analyzes the situation of the user using a user apparatus 12 based on the position information of the user apparatus 12. The situation analyzing unit 121 notifies the totaling unit 122 and the recommending unit 124 of the analysis result of the situation.

Note that the criteria for sorting the situation may be set arbitrarily within a range where sorting is possible based on the position information of the user apparatus 12. As examples, it is possible to sort into situations based on pinpoint position information such as “at the sea”, “in the mountains”, “at a resort”, and “in the city” and to sort into situations based on changes in a time series of the position information, such as when moving by train or driving. Situations based on pinpoint position information may be sorted according to broad classifications such as “at the beach” or “in the mountains” or may be more precisely sorted using specific place names or the like. Also, situations based on changes in a time series of the position information may or may not be used to specify a location. When using such changes to specify a location, it is possible to sort into “driving by the coast”, “moving by train in the city”, and the like.

The totaling unit 122 totals the user evaluation information gathered from user apparatuses 12 and information relating to the recommended song lists transmitted to such user apparatuses 12, and stores the results of totaling in the totaled information storage unit 151 and/or supplies the results to the vector generating unit 123.

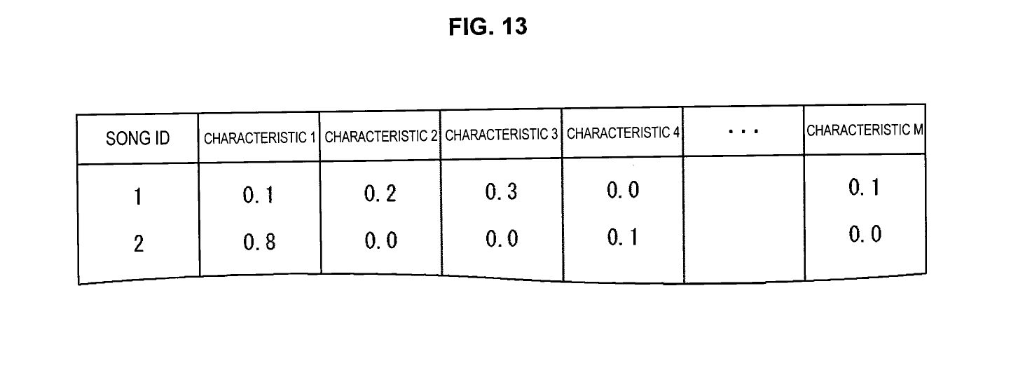

The default vector generating unit 131 generates a default vector used to recommend songs in keeping with user attributes and the like. More specifically, the default vector generating unit 131 uses the results of totaling produced by the totaling unit 122 and a song characteristic database (see FIG. 13) in the song information storage unit 153 to generate client type-based vectors expressing the characteristics of songs liked by users for each client type of the user apparatuses 12, region-based vectors expressing the characteristics of songs liked by users for each region to which users belong, and age-based vectors expressing the characteristics of songs liked by users for each age or age bracket of users. The default vector generating unit 131 stores the generated client type-based vectors, region-based vectors, and age-based vectors in the vector storage unit 154.

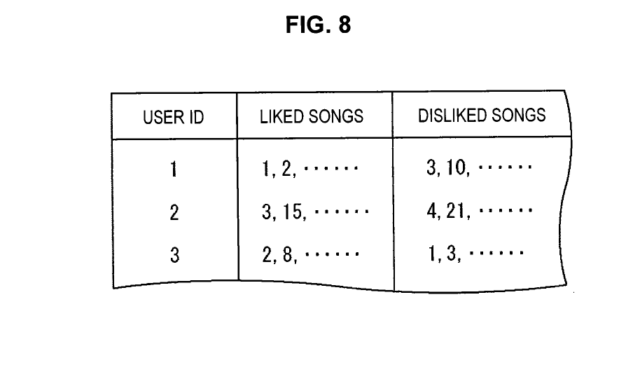

As described later, the user taste vector generating unit 132 uses a user evaluation database (see FIG. 8) in the totaled information storage unit 151 and the song characteristic database (see FIG. 13) in the song information storage unit 153 to generate, for each user, a user taste vector expressing the characteristics of songs liked by such user. The user taste vector generating unit 132 stores the generated user taste vectors in the vector storage unit 154.

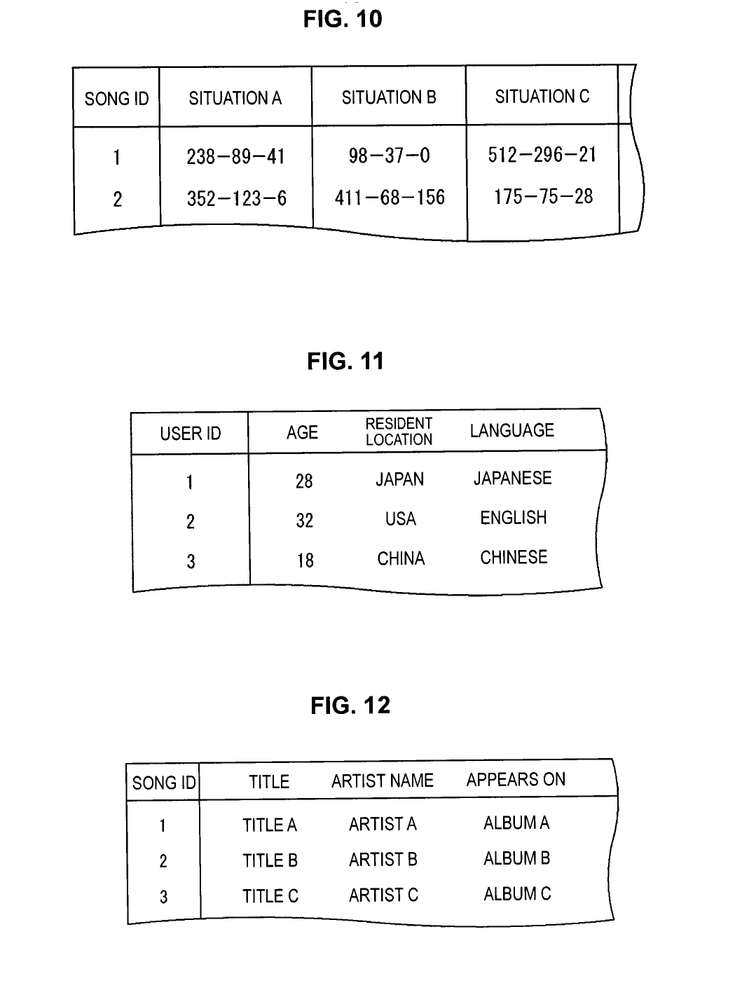

The situation vector generating unit 133 generates situation vectors to be used when recommending songs in keeping with the user's situation. More specifically, the situation vector generating unit 133 uses a situation-based song evaluation database (see FIG. 10) in the totaled information storage unit 151 and the song characteristic database (see FIG. 13) in the song information storage unit 153 to generate situation vectors. The situation vector generating unit 133 stores the generated situation vectors in the vector storage unit 154.

The priority vector generating unit 134 is operable, when a user has provided a positive evaluation to a song, to generate a priority vector expressing the characteristics of such song or characteristics of the artist of such song. The priority vector generating unit 134 supplies the generated priority vector to the recommending unit 124.

As described later, the recommending unit 124 uses the user attribute-based song evaluation database in the totaled information storage unit 151, a user attribute database in the user information storage unit 152, a song attribute database and the song characteristic database in the song information storage unit 153, the various vectors stored in the vector storage unit 154, song rankings received from the song ranking distributing server 15, and indicated attributes indicated by the user to generate a recommended song list. The recommending unit 124 supplies the generated recommended song list to the transmission/reception unit 101.

The distributing unit 125 receives a song ID transmitted from the user apparatus 12 via the communication network 18 and the transmission/reception unit 101. The distributing unit 125 also acquires song data associated with the received song ID from the song information storage unit 153 and transmits the song data via the transmission/reception unit 101 to the user apparatus 12 that issued the request.

As one example, the display control unit 126 controls the displaying of screens that enable the user apparatus 12 to make use of the services provided by the song distributing server 14. More specifically, the display control unit 126 generates display control data including a display program, data, and the like in accordance with various requests received from the user apparatus 12 via the communication network 18 and the transmission/reception unit 101 and transmits the display control data via the transmission/reception unit 101 to the user apparatus 12. Based on the received display control data, the user apparatus 12 displays a specified screen and/or updates the displaying of a screen.

Note that although the various screens displayed on the user apparatus 12 are divided into screens that are displayed based on display control data supplied from the display control unit 126 of the song distributing server 14 and screens that are displayed by the user apparatus 12 by itself, the classification into such types can be set arbitrarily.

The totaled information storage unit 151 is configured using the hard disk drive 23 or a separate database, not shown, and stores the user evaluation database whose data structure is schematically shown in FIG. 8. The user evaluation database is a database in which evaluations to songs by respective users are totaled and shows taste information about songs for respective users. In the user evaluation database, a user ID and song IDs of songs for which the user has provided a positive evaluation (“liked songs”) and songs for which the user has provided a negative evaluation (“disliked songs”) are associated.

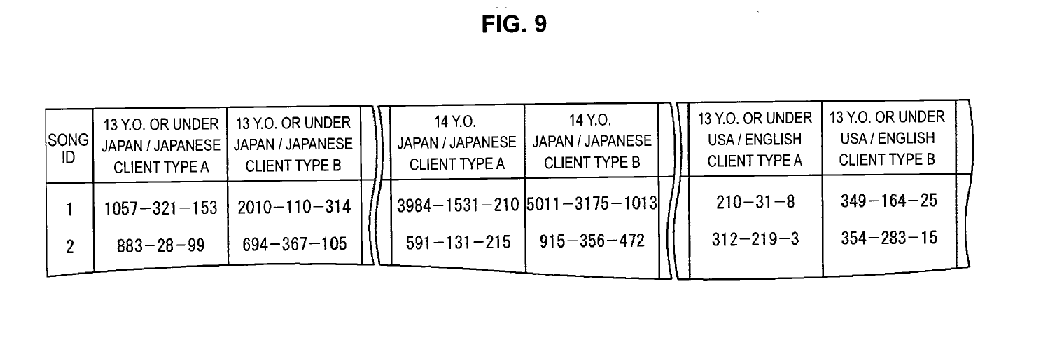

In addition, the totaled information storage unit 151 stores the user attribute-based song evaluation database with the data structure schematically shown in FIG. 9, for example. The song evaluation database is a database in which the evaluations to respective songs are totaled for each user attribute. In the user attribute-based song evaluation database, the song IDs are associated with total values showing evaluations to the songs for each user attribute.

As one example, the user attributes are sorted according to age, resident location (i.e., the region to which the user belongs), language, and combination of client types of user apparatuses 12 used by the user. Note that if a single user uses the service on a plurality of user apparatuses 12, the evaluations to songs by such user are totaled by being sorted into the client types. Also, as information showing the age of each user, it is possible to user information indirectly showing the user's age, such as the user's date of birth.

Also, the total values include for example, three values including the number of times a song is included in a song list transmitted to the user apparatus 12 (hereinafter referred to as the “distribution frequency x”), the number of times a positive evaluation has been transmitted from a user apparatus 12 for such song (hereinafter referred to as the “positive evaluation frequency y”) and the number of times a negative evaluation has been transmitted from a user apparatus 12 for such song (hereinafter referred to as the “negative evaluation frequency z”).

In addition, as one example the totaled information storage unit 151 stores a situation-based song evaluation database whose data structure is schematically shown in FIG. 10. The situation-based song evaluation database is a database in which evaluations to songs are totaled for each situation. In the situation-based song evaluation database, a song ID is associated with the total values showing the user evaluations to such song in each situation.

Note that in the same way as the user attribute-based song evaluation database in FIG. 9, the total values include for example three values including the distribution frequency x, the positive evaluation frequency y, and the negative evaluation frequency z.

The user information storage unit 152 is configured using the hard disk drive 23 or a separate database, not shown, and stores information relating to the respective users of the content recommendation system 10.

As one example, the user information storage unit 152 stores a user attribute database with the data structure schematically shown in FIG. 11. The user attribute database is a database for managing the attributes of the respective users and associates a user ID and attributes such as age, resident location, language, and the like together. Note that the data in the user attribute database is capable of being registered from the respective user apparatuses 12.

The song information storage unit 153 is configured using the hard disk drive 23 or a separate database, not shown, and stores information relating to the songs distributed in the content recommendation system 10.

For example, the song information storage unit 153 stores the song IDs and the data of the corresponding songs associated with one another. Note that in cases such as when the same song is recorded on a plurality of albums, a plurality of song data may be present for the same song. In such case, a different song ID is assigned to each incidence of the song data.

As one example, the song information storage unit 153 stores a song information database with the data structure schematically shown in FIG. 12. The song information database is a database for managing information relating to songs to be distributed, and associates each song ID with information relating to the song, such as the song title, artist name, albums the song appears on, and the like.

In addition, as one example, the song information storage unit 153 stores a song characteristic database with the data structure schematically shown in FIG. 13, for example. The song characteristic database is a database for managing characteristic values expressing the characteristics of songs. The song characteristic database associates the song IDs with characteristic values for characteristics 1 to M of songs corresponding to the song IDs. As the characteristics 1 to M, as examples, the tempo of the song, the extent to which sounds of a specified frequency are included in the song, the frequency with which a specified keyword is included in the description text of the song, and the like are used. Note that the characteristic values of each song may be manually assigned or may be found by an analysis process carried out by a computer.

Note that a vector that has the characteristic values of the characteristics 1 to M as components and expresses the characteristics of a song is called a “characteristic vector”.

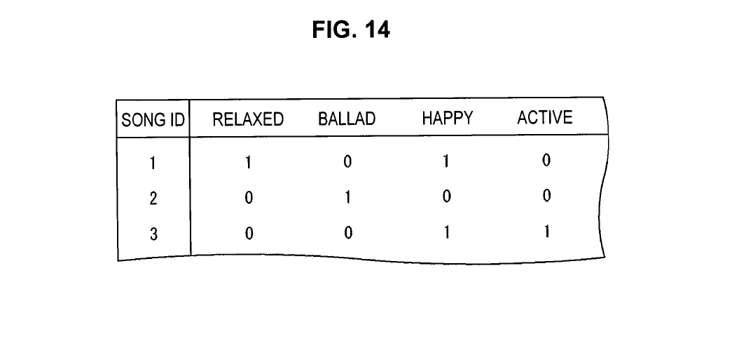

The song information storage unit 153 also stores a song attribute database with the data structure schematically shown in FIG. 14, for example. The song attribute database is a database for managing the attributes of songs. In the song attribute database, the song IDs are associated with flags showing whether the songs corresponding to the song IDs have various attributes. As one example, the song attributes are song moods such as “relaxed”, “ballad”, “happy”, and “active” and are found for example by an analysis process carried out by a computer.

The vector storage unit 154 is configured using the hard disk drive 23 or a separate database, not shown, and stores the default vectors, the user taste vectors, the situation vectors, and the like.

### Example Configuration of Recommending Unit 124

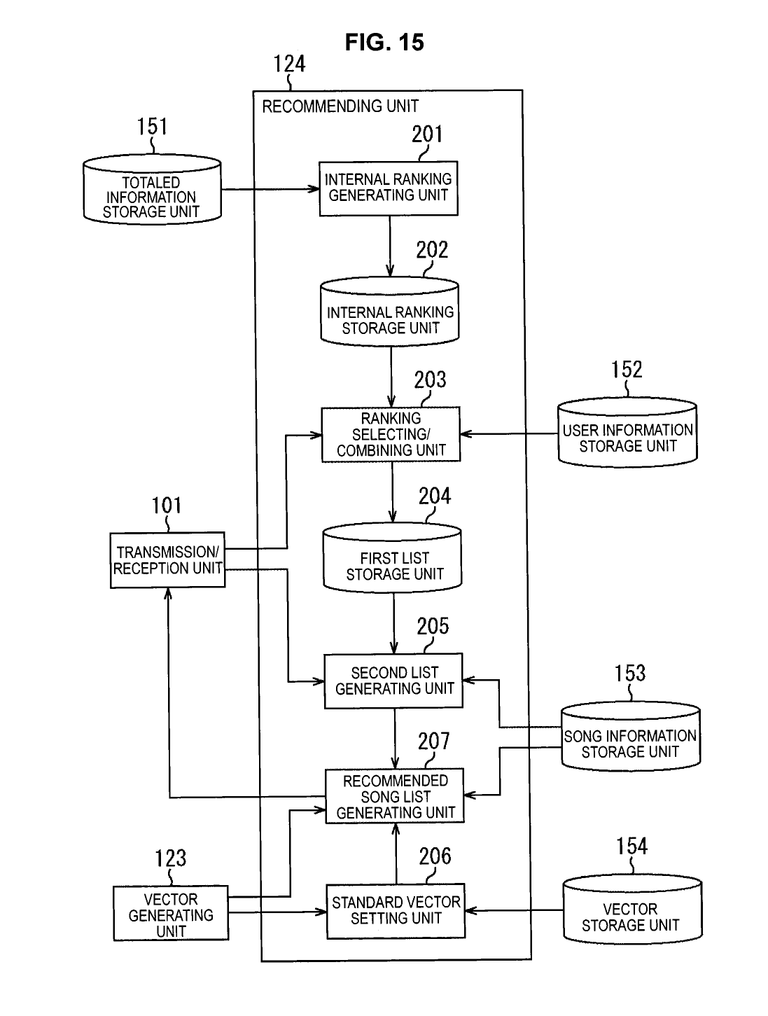

Next, the functional configuration of the recommending unit 124 of the song distributing server 14 will be described. FIG. 15 is a functional block diagram of the recommending unit 124.

The recommending unit 124 is functionally configured from an internal ranking generating unit 201, an internal ranking storage unit 202, a ranking selecting/combining unit 203, a first list storage unit 204, a second list storage unit 205, a standard vector setting unit 206, and a recommended song list generating unit 207.

The internal ranking generating unit 201 regularly (every week or every month, for example) generates rankings (hereinafter referred to as “internal rankings”) of songs for a range of each type of user attribute based on the user attribute-based song evaluation database in the totaled information storage unit 151. The internal ranking generating unit 201 stores the generated internal rankings in the internal ranking storage unit 202.

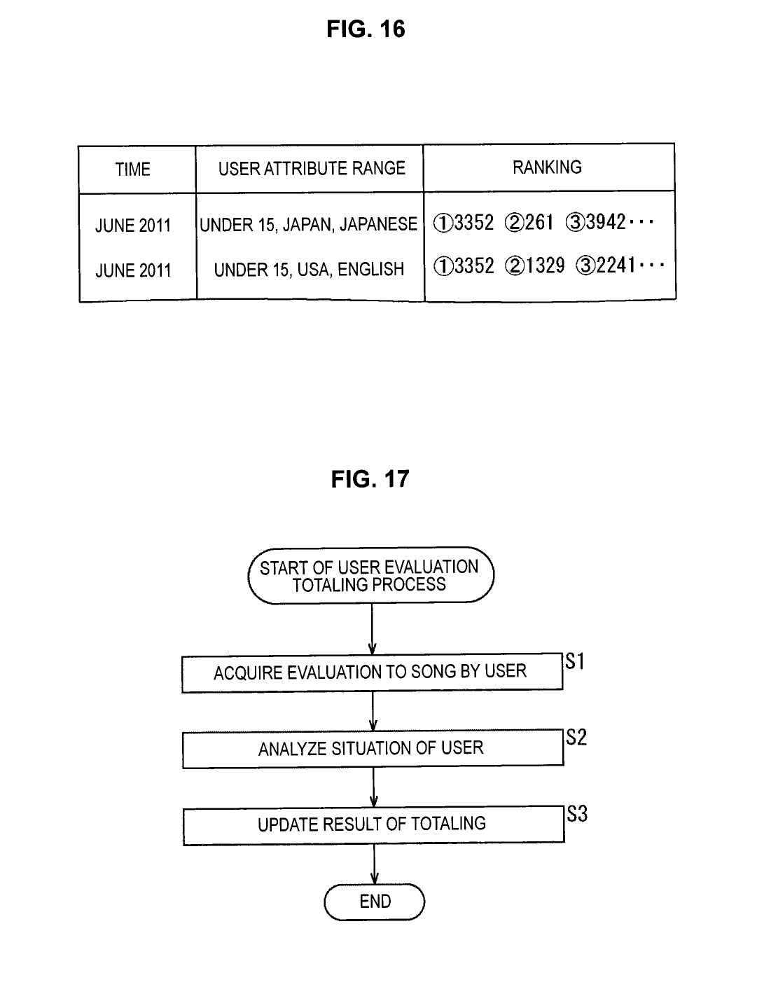

The internal ranking storage unit 202 is configured using the hard disk drive 23 or a separate database, not shown. As shown in FIG. 16, the internal ranking storage unit 202 stores rankings of each type generated by the internal ranking generating unit 201 in association with such ranking's time of generation and a range of user attributes.

As one example, the ranking of songs liked by users who are fifteen years old or under, whose resident location is Japan, and whose language is Japanese is generated by placing the song IDs of a specified number of songs (for example, 100) in descending order of total value of the positive evaluation frequency y recorded in the columns “13 or under/Japan/Japanese”, “14y.o./Japan/Japanese”, and “15y.o./Japan/Japanese” in the user attribute-based song evaluation database in FIG. 9. At this time, as one example, rankings may be generated by placing the song IDs of a specified number of songs in order of the ratio of the total value of the positive evaluation frequency y to the total value of the distribution frequency x, that is, the ratio of a number of times a positive evaluation has been provided relative to the number of times the song was recommended.

The ranking selecting/combining unit 203 reads the user attributes associated with the user ID included in a song list request transmitted from a user apparatus 12 from the user attribute database in the user information storage unit 152. The ranking selecting/combining unit 203 also reads the internal rankings associated with the read user attributes from the internal ranking storage unit 202. In addition, the ranking selecting/combining unit 203 receives song rankings (hereinafter, referred to as “external rankings”) corresponding to such user attributes from the song ranking distributing server 15 via the transmission/reception unit 101 and the communication network 18. The ranking selecting/combining unit 203 then combines the songs IDs included in the two acquired rankings to generate a first list. The ranking selecting/combining unit 203 stores the generated first list in the first list storage unit 204.

The first list storage unit 204 is configured using the hard disk drive 23 or a separate database, not shown, and stores the first list.

The second list storage unit 205 reads the first list from the first list storage unit 204. The second list storage unit 205 then narrows down the song IDs included in the first list based on the indicated attributes included in the song list request and the song attribute database in the song information storage unit 153 to generate a second list. The second list storage unit 205 supplies the generated second list to the recommended song list generating unit 207.

The standard vector setting unit 206 sets a standard vector used to recommend content. More specifically, the standard vector setting unit 206 generates the standard vector by selecting a standard vector from a variety of vectors stored in the vector storage unit 154 or by combining such stored vectors. The standard vector setting unit 206 supplies the set standard vector to the recommended song list generating unit 207.

The recommended song list generating unit 207 generates a recommended song list using the song characteristic database in the song information storage unit 153, the second list supplied from the second list storage unit 205, the priority vector supplied from the priority vector generating unit 134 of the vector generating unit 123, and the standard vector supplied from the standard vector setting unit 206. The recommended song list generating unit 207 supplies the generated recommended song list to the transmission/reception unit 101.

### Processing of Content Recommendation System 10

Next, the processing carried out by the content recommendation system 10 will be described.

User Evaluation Totaling Process

First, a user evaluation totaling process carried out by the song distributing server 14 will be described with reference to the flowchart in FIG. 17.

In step S1, the song distributing server 14 acquires a user evaluation to a song.

As one example, during reproduction of a song, the user is capable of using the operation device 36 of the user apparatus 12 to input an evaluation to the song being reproduced. When an evaluation has been inputted by the user, the operation unit 61 of the user apparatus 12 transmits user evaluation information, which indicates the inputted evaluation and includes the song ID of the song being reproduced, the user ID, and the client type ID and position information of the user apparatus 12, via the communication interface 39 to the song distributing server 14.

Note that input of an evaluation is not limited to during the reproduction of a song and it may also be possible for the user to select a song that is not being reproduced and input an evaluation to the selected song to have corresponding user evaluation information transmitted from the user apparatus 12 to the song distributing server 14.

Also as one example, if a skip operation has been carried out for the operation device 36 during reproduction of a song, the operation unit 61 may notify the song reproduction unit 62. In keeping with such notification, the song reproduction unit 62 stops the reproduction of the song, transmits the next song ID to the song distributing server 14 and reproduces the song data received in reply. At this time, the operation unit 61 transmits user evaluation information, which indicates a negative evaluation and includes the song ID of the song that was skipped, the user ID, and the client type ID and position information of the user apparatus 12, via the communication interface 39 to the song distributing server 14.

Also, as another example, on reproducing a song to the end without skipping, the song reproduction unit 62 notifies the operation unit 61. In this case, the operation unit 61 transmits user evaluation information, which indicates a positive evaluation and includes the song ID of the song that was reproduced to the end, the user ID, and the client type ID and position information of the user apparatus 12, via the communication interface 39 to the song distributing server 14.

Note that if the user apparatus 12 does not have the functions of the position information acquiring unit 63, position information of the user apparatus 12 is not included in the user evaluation information.

The transmission/reception unit 101 of the song distributing server 14 receives the user evaluation information transmitted as described above from the respective user apparatuses 12 via the communication network 18.

In step S2, the situation analyzing unit 121 analyzes the situation of the user based on the position information of the user apparatus 12. More specifically, the transmission/reception unit 101 notifies the situation analyzing unit 121 of the position information of the user apparatus 12 included in the user evaluation information and requests analysis of the user's situation. Based on the position information of the user apparatus 12, the situation analyzing unit 121 specifies the situation of the user who gave the evaluation to the song out of situations set in the situation-based song evaluation database in FIG. 10. The situation analyzing unit 121 supplies information showing the specified situation of the user to the totaling unit 122.

Note that if position information is not included in the user evaluation information, the processing in step S2 is skipped.

In step S3, the totaling unit 122 updates the results of totaling stored in the totaled information storage unit 151 based on the acquired user evaluation information and the analysis results for the user's situation. More specifically, the transmission/reception unit 101 supplies the user evaluation information to the totaling unit 122 and requests updating of the results of totaling.

As one example, if the user evaluation information indicates a positive evaluation, the totaling unit 122 adds the song ID indicated in the user evaluation information to liked songs of the user ID indicated in the user evaluation information in the user evaluation database in FIG. 8. Meanwhile, if the user evaluation information indicates a negative evaluation, the totaling unit 122 adds the song ID indicated in the user evaluation information to disliked songs of the user ID indicated in the user evaluation information in the user evaluation database in FIG. 8.

The totaling unit 122 also reads the attributes of the user corresponding to the user ID indicated in the user evaluation information from the user attribute database in the user information storage unit 152. In addition, based on the read user attributes and the client type ID indicated in the user evaluation information, the totaling unit 122 specifies a user attribute range to which the user who gave the evaluation to the song belongs in the user attribute-based song evaluation database in FIG. 9. The totaling unit 122 then updates the total values of the specified user attribute range in the user attribute-based song evaluation database in FIG. 9. More specifically, if a positive evaluation is indicated in the user evaluation information, the totaling unit 122 adds one to the positive evaluation frequency y in the total values, while if a negative evaluation is indicated, the totaling unit 122 adds one to the negative evaluation frequency z in the total values.

In addition, the totaling unit 122 updates the total values for the situation specified by the situation analyzing unit 121 in the situation-based song evaluation database in FIG. 10. More specifically, if a positive evaluation is indicated in the user evaluation information, the totaling unit 122 adds one to the positive evaluation frequency y, while if a negative evaluation is indicated, the totaling unit 122 adds one to the negative evaluation frequency z in the total values.

After this, the user evaluation totaling process ends.

### Default Vector Generating Process

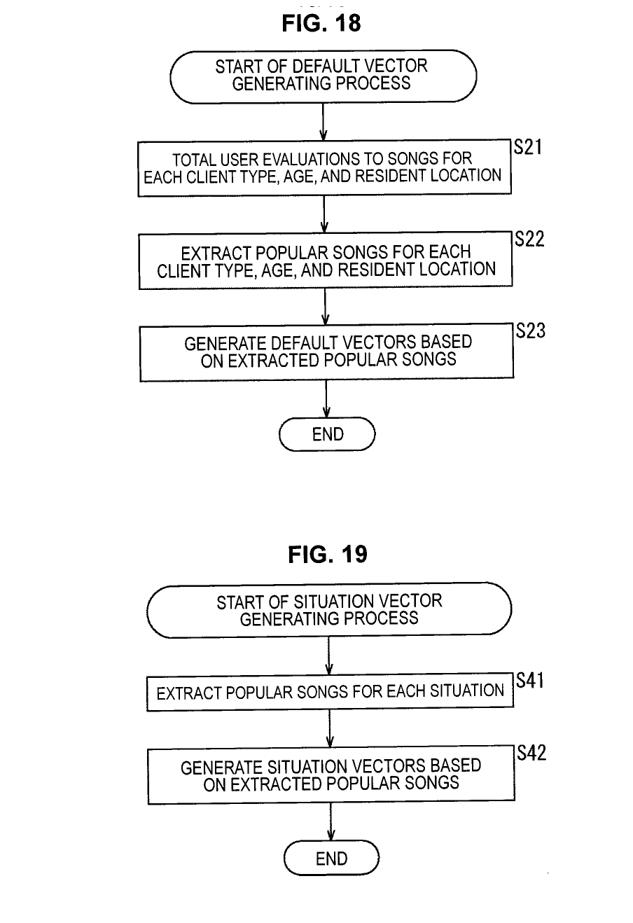

Next, a default vector generating process carried out by the song distributing server 14 will be described with reference to the flowchart in FIG. 18.

Note that this process is commenced regularly or when specified conditions are satisfied, for example. Note that the expression “when specified conditions are satisfied” includes for example a case such as when the number of user evaluations to songs has increased by a specified number or more from when the default vector generating process was last carried out.

In step S21, the totaling unit 122 totals the evaluations to songs by users for each client type, age, and each resident location. More specifically, the totaling unit 122 totals the distribution frequency x, the positive evaluation frequency y, and the negative evaluation frequency z of each song respectively for each client type, each age, and each resident location based on the user attribute-based song evaluation database in the totaled information storage unit 151. The totaling unit 122 then supplies the result of totaling to the vector generating unit 123.

In step S22, the default vector generating unit 131 extracts popular songs for each client type, each age, and each resident location.

More specifically, based on the results of totaling of the user evaluations to songs for each client type, the default vector generating unit 131 extracts a plurality of popular songs that have favorable evaluations for respective client types.

Note that it is possible to use an arbitrary method as the method of extracting popular songs. As one example, for a given client type, songs for which the positive evaluation frequency y is equal to or above a specified value or a specified number of songs with the highest positive evaluation frequencies y may be extracted as popular songs for such client type. Alternatively, for a given client type, out of songs for which the positive evaluation frequency y is equal to or above a specified value, songs for which the ratio of the positive evaluation frequency y to the distribution frequency x is a specified value or above or a specified number of songs with the highest ratios of the positive evaluation frequency y to the distribution frequency x may be extracted as popular songs for such client type. Alternatively, for a given client type, out of songs for which the positive evaluation frequency y is equal to or above a specified value, songs for which the ratio of the positive evaluation frequency y to the negative evaluation frequency z is a specified value or above or a specified number of songs with the highest ratios of the positive evaluation frequency y to the negative evaluation frequency z may be extracted as popular songs for such client type.

By carrying out the same processing, the default vector generating unit 131 also extracts a plurality of popular songs for each user age and each user resident location. Note that at this time, popular songs may be extracted for each age bracket (for example, twenties) including a plurality of ages and/or popular songs may be extracted for a region (for example, North America) including a plurality of resident locations.

In step S23, the default vector generating unit 131 generates a default vector based on the extracted popular songs.

More specifically, for each client type, the default vector generating unit 131 generates a client type-based vector based on the characteristic values of the extracted popular songs. For example, the default vector generating unit 131 reads characteristic values of popular songs for a given client type from the song characteristic database in the song information storage unit 153. The default vector generating unit 131 then calculates average values for each read characteristic value of the popular songs and generates, as a client type-based vector corresponding to such client type, a vector that has the calculated average values as components. Note that at this time, by adding weightings in accordance with the popularity of songs, it is possible to generate client type-based vectors that have weighted averages for each characteristic of the characteristic values of popular songs as components.

Accordingly, client-type based vectors express the characteristics of songs liked by users for each client type of the user apparatuses 12 being used.

Also, by carrying out the same processing, the default vector generating unit 131 generates an age-based vector for each age of users. Accordingly, the age-based vectors express the characteristic values of songs liked by users for each age of users. Note that when doing so, if popular songs have been extracted for specified age brackets, an age-based vector is generated for each age bracket.

In addition, by carrying out the same processing, the default vector generating unit 131 generates a location-based vector for each resident location of users. Accordingly, the location-based vectors express the characteristics of songs liked by users for each resident location of users. Note that when doing so, if popular songs have been extracted for specified regions, a region-based vector is generated for each region.

The default vector generating unit 131 then stores the generated client type-based vector, age-based vector, and location-based vector in the vector storage unit 154.

After this, the default vector generating process ends.

### Situation Vector Generating Process

Next, a situation vector generating process carried out by the song distributing server 14 will be described with reference to the flowchart in FIG. 19.

Note that this process is commenced regularly or when specified conditions are satisfied, for example. Note that the expression “when specified conditions are satisfied” includes cases such as when the number of user evaluations to songs has increased by a specified number or more from when the situation vector generating process was last carried out, for example.

In step S41, the situation vector generating unit 133 extracts popular songs for each situation. More specifically, by carrying out the same processing as step S22 in FIG. 18, the situation vector generating unit 133 extracts a plurality of popular songs that have favorable evaluations for respective situations based on the situation-based song evaluation database in the totaled information storage unit 151.

In step S42, the situation vector generating unit 133 generates situation vectors based on the extracted popular songs. More specifically, by carrying out the same processing as when the client type-based vectors are generated, the situation vector generating unit 133 generates situation vectors based on the characteristic values of the extracted popular songs for each situation. Accordingly, the situation vectors express the characteristics of songs liked by users for each user situation.

The situation vector generating unit 133 then stores the generated situation vectors in the vector storage unit 154.

After this, the situation vector generating process ends.

### Song Recommendation Process

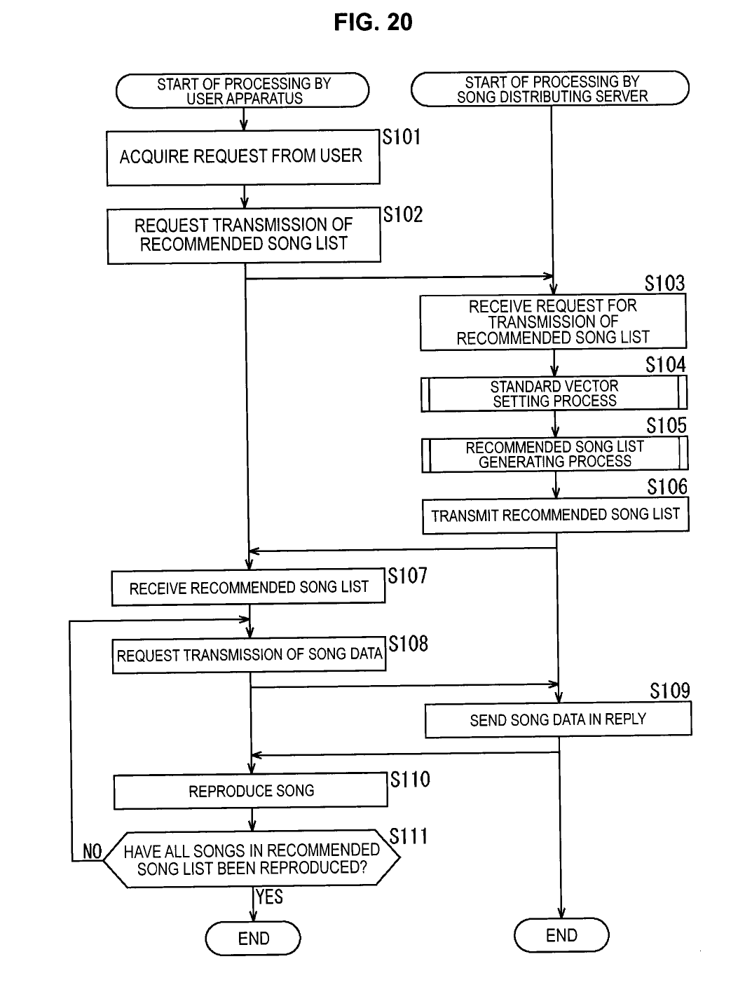

Next, a song recommendation process carried out by the content recommendation system 10 will be described with reference to the flowchart in FIG. 20.

Note that in the following description, a user to whom songs are distributed via the user apparatus 12 is referred to as the “active user”.

In step S101, the user apparatus 12 acquires a request from the user (active user). More specifically, when the active user wishes to have a song distributed from the song distributing server 14, the active user inputs a request for the distribution of a song using the operation device 36. At this time, the active user indicates the attributes of the song the user wishes to have distributed (for example, a song mood such as “relaxed”, “ballad”, “happy”, and “active”). Note that the song attributes do not have to be indicated by the active user and may be randomly selected by the user apparatus 12. The operation unit 61 then acquires the request for the distribution of a song inputted by the active user.

In step S102, the operation unit 61 requests transmission of a recommended song list. More specifically, the operation unit 61 generates a song list request corresponding to the request by the active user and transmits the song list request via the communication interface 39 to the song distributing server 14. The song list request includes the user ID of the active user, the indicated attributes, and the client ID and position information of the user apparatus 12.

Note that if the user apparatus 12 does not have the functions of the position information acquiring unit 63, position information of the user apparatus 12 is not included in a song list request.

In step S103, the transmission/reception unit 101 of the song distributing server 14 receives the song list request via the communication network 18 from the user apparatus 12.

In step S104, the song distributing server 14 carries out the standard vector setting process.

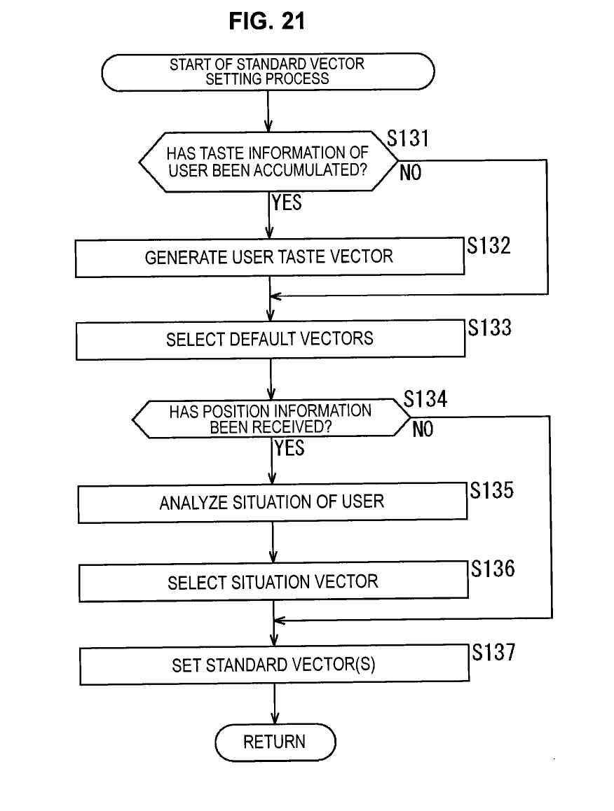

Here, the standard vector setting process will be described in detail with reference to the flowchart in FIG. 21.

In step S131, the user taste vector generating unit 132 determines whether taste information of the user (active user) has been accumulated. More specifically, the transmission/reception unit 101 notifies the user taste vector generating unit 132 of the user ID included in the song list request and requests generation of a user taste vector. The user taste vector generating unit 132 searches the user evaluation database in the totaled information storage unit 151 for song IDs of liked songs associated with the notified user ID. If song IDs of liked songs associated with the notified user ID are found, the user taste vector generating unit 132 determines that taste information of the active user has been accumulated and the processing proceeds to step S132.

In step S132, the user taste vector generating unit 132 generates a user taste vector. More specifically, the user taste vector generating unit 132 reads the characteristic values of the song ID(s) found by the processing in step S131 from the song characteristic database in the song information storage unit 153. The user taste vector generating unit 132 then generates the user taste vector based on the read characteristic values of the song(s). As one example, the user taste vector generating unit 132 calculates average values for each characteristic of the read characteristic values of the song(s) and generates a vector that has the calculated average values as components as the user taste vector. The user taste vector generating unit 132 then supplies the generated user taste vector to the standard vector setting unit 206.

After this the processing proceeds to step S133.

Meanwhile, if in step S131, the user taste vector generating unit 132 is unable to find a liked song associated with the notified user ID, it is determined that taste information has not been accumulated for the active user. The processing in step S132 is then skipped and the processing proceeds to step S133.

That is, in this case, since taste information of the active user has not been accumulated, a user taste vector is not generated. As examples, this could conceivably be due to the active user being a first-time user using the service for the first time or the active user having only just started using the service.

In step S133, the standard vector setting unit 206 selects the default vector. More specifically, the transmission/reception unit 101 notifies the standard vector setting unit 206 of the user ID and the client type ID included in the song list request and requests the standard vector setting unit 206 to select a default vector.

The standard vector setting unit 206 reads the attributes of the active user corresponding to the notified user ID from the user attribute database in the user information storage unit 152. The standard vector setting unit 206 reads the age-based vector corresponding to the age of the active user and the region-based vector corresponding to the resident location of the active user from the vector storage unit 154. The standard vector setting unit 206 also reads the client type-based vector corresponding to the notified client type ID from the vector storage unit 154.

In step S134, the transmission/reception unit 101 determines whether position information has been received. If position information of the user apparatus 12 is included in the received song list request, the transmission/reception unit 101 determines that position information has been received and the processing proceeds to step S135.

In step S135, in the same way as the processing in step S2 in FIG. 17, the situation of the active user is analyzed and the present situation of the active user is specified.

In step S136, the standard vector setting unit 206 selects a situation vector. More specifically, the situation analyzing unit 121 notifies the standard vector setting unit 206 of the analysis result of the situation of the active user and requests the standard vector setting unit 206 to select the situation vector. The standard vector setting unit 206 reads a situation vector corresponding to the situation of the specified active user from the vector storage unit 154.

After this, the processing proceeds to step S137.

Meanwhile, if, in step S134, position information of the user apparatus 12 is not included in the received song list request, the transmission/reception unit 101 determines that position information has not been received. The processing in steps S135 and S136 is then skipped, and the processing proceeds to step S137.

In step S137, the standard vector setting unit 206 sets the standard vector. More specifically, the standard vector setting unit 206 selects candidate vectors that are candidates for one or more standard vectors out of the three types of default vector selected by the processing in step S133, the user taste vector generated by the processing in step S132, and the situation vector selected by the processing in step S136.

Note that depending on the determination results in step S131 and S134 described above, there are cases where the user taste vector and the situation vector are not included in the vectors that can be selected as the candidate vectors. For example, if the active user is a first-time user, a user taste vector will not be included in the vectors that can be selected as the candidate vectors. In addition, if the active user is a first-time user, the situation vector may be excluded from the vectors that can be selected and only the default vectors may be set as the vectors that can be selected as the candidate vectors.

At this time, a single candidate vector may be selected or a plurality of candidate vectors may be selected. In addition, the candidate vectors may be selected randomly or may be selected according to specified criteria.

Note that if the candidate vector is selected according to specified criteria, it is desirable to set the selection criteria so that a vector that is close to the taste of the active user is selected with priority. Here, the expression “a vector that is close to the taste of the active user” refers for example to a vector which, when used to recommend songs, has a higher probability of recommending songs that match the taste of the active user.

Such selection criteria can be set for example by the service provider based on the result of field tests or the like and/or can be automatically generated by a learning process. As another example, since the precision of the user taste vector will increase as the amount of taste information accumulated for the active user increases, the selection criteria may be set so that the user taste vector is selected with higher priority. In addition, as one example, the types of vectors used to recommend songs for which the user has provided an evaluation may be totaled and the selection criteria may be set so that the priority order of a vector is set higher the higher the frequency or ratio with which such vector was used to recommend songs for which the active user has provided a positive evaluation and so that the priority order of a vector is set lower the higher the frequency or ratio with which such vector was used to extract songs for which a negative evaluation was provided.

If a plurality of candidate vectors have been selected, the selected candidate vectors may be individually set as standard vectors, or a standard vector may be generated by combining the plurality of candidate vectors. Note that if three or more candidate vectors have been selected, all of the selected candidate vectors may be combined or some of the candidate vectors may be combined. Also, if three or more candidate vectors have been selected, by combining the candidate vectors according to different combinations, a plurality of standard vectors may be generated.

In addition, if a plurality of candidate vectors are combined, it is possible to combine the vectors with equal ratios or to combine the vectors with different ratios. If the vectors are combined with different ratios, it is desirable to set the ratios for combining of vectors that are close to the taste of the active user higher.

In the same way as the selection criteria described above, the combining ratios can be set for example by the service provider based on the result of field tests or the like and/or can be automatically generated by a learning process. As another example, the ratio for combining the user taste vector may be set higher the larger the amount of taste information accumulated for the active user.

Also, if a standard vector has been generated by combining a plurality of candidate vectors, the candidate vectors before combining may also be set as standard vectors. As one example, if the candidate vector A and the candidate vector B have been combined to generate the standard vector C, one or both of the candidate vector A and the candidate vector B may also be set as standard vectors.

By carrying out the processing described above, one or more standard vectors is/are set.

After this, the standard vector setting process ends.

The processing then returns to FIG. 20 and in step S105, the recommending unit 124 carries out a recommended song list generating process.

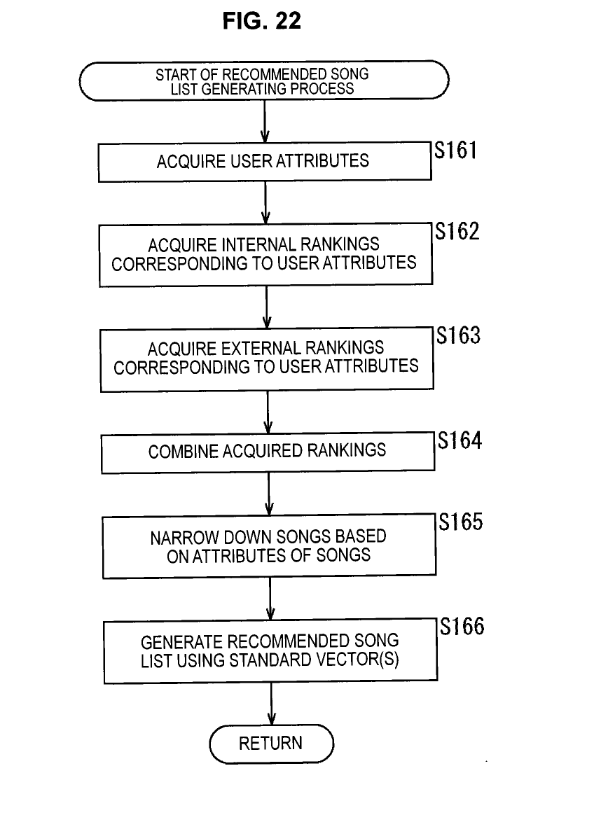

Here, the recommended song list generating process in step S105 will now be described in detail with reference to the flowchart in FIG. 22.

In step S161, the ranking selection combining unit 203 acquires the user attributes. More specifically, the transmission/reception unit 101 notifies the ranking selection combining unit 203 of the user ID included in the song list request and requests combining of rankings. The ranking selection combining unit 203 reads the user attributes corresponding to the notified user ID from the user attribute database in the user information storage unit 152.

In step S162, the ranking selection combining unit 203 acquires internal rankings corresponding to the user attributes. That is, the ranking selection combining unit 203 reads out internal rankings corresponding to a range of user attributes including the read user attributes from the internal ranking storage unit 202. Note that when doing so, internal rankings corresponding to a range adjacent to the range of user attributes of the read internal rankings may also be read out.

In step S163, the ranking selection combining unit 203 acquires the external rankings corresponding to the user attributes. That is, the ranking selection combining unit 203 receives the external rankings corresponding to the read user attributes via the transmission/reception unit 101 and the communication network 18 from the song ranking distributing server 15. For example, the ranking selection combining unit 203 receives the latest rankings for the resident location (country) of the active user or, based on the age of the active user, receives rankings issued at such resident location for a case where the active user is fifteen years old.

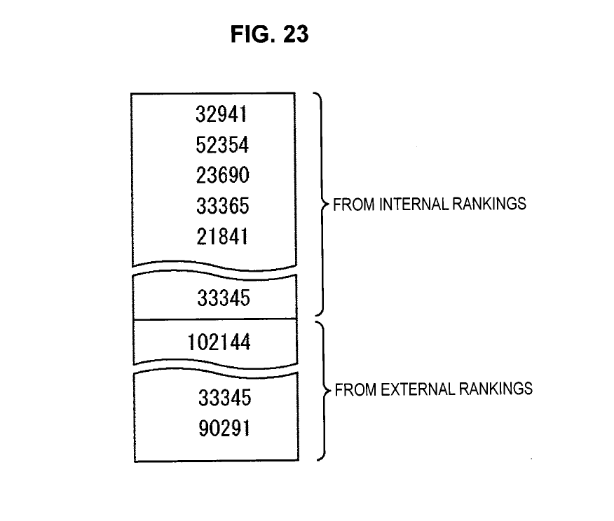

In step S164, the ranking selection combining unit 203 combines the acquired rankings. More specifically, as one example, the ranking selection combining unit 203 generates a list (“first list”) in which the song IDs included in the acquired internal rankings and the song IDs included in the external rankings are combined, as schematically shown in FIG. 23. Note that at this time, it is not necessary for every song ID included in the respective rankings to be included in the first list. The ranking selection combining unit 203 stores the generated first list in the first list storage unit 204.

In step S165, the second list generating unit 205 further narrows the selection of songs based on the attributes of the songs. More specifically, the transmission/reception unit 201 notifies the second list generating unit 205 of the indicated attribute included in the song list request and requests generation of the recommended song list. The second list generating unit 205 reads the first list generated by the ranking selection combining unit 203 from the first list storage unit 204. Also, the second list generating unit 205 reads the song attributes associated with the respective song IDs included in the first list from the song attribute database in the song information storage unit 153. In addition, the second list generating unit 205 extracts the song IDs with the indicated attribute out of the song IDs included in the first list. The second list generating unit 205 then generates a second list including the extracted song IDs. The second list generating unit 205 supplies the generated second list to the recommended song list generating unit 207.

In step S166, the recommended song list generating unit 207 generates the recommended song list using the standard vector.

Note that the method of generating the recommended song list will greatly differ when the number of standard vectors set by the standard vector setting unit 206 is one and when the number is two or more. For this reason, the method of generating the recommended song list when the number of set standard vectors is one will be described first.

For example, the recommended song list generating unit 207 reads the characteristic values associated with the song IDs included in the second list from the song characteristic database in the song information storage unit 153. The recommended song list generating unit 207 calculates the similarity between characteristic vectors including the characteristic values of each song ID and the standard vector and sorts the song IDs in the second list into descending order of similarity. By doing so, songs (i.e., the IDs of songs) that resemble the characteristics expressed by the standard vector are disposed at the top of the second list.

As one example, the recommended song list generating unit 207 then generates a list including a specified number of song IDs at the top of the second list after sorting as the recommended song list.

Next, the method of generating the recommended song list when the number of standard vectors set by the standard vector setting unit 206 is two or more will be described.

As one example, the recommended song list generating unit 207 reads the characteristic values associated with the song IDs included in the second list from the song characteristic database in the song information storage unit 153. After this, for each of the standard vectors, the recommended song list generating unit 207 calculates the similarity between characteristic vectors including the characteristic values of each song ID and the standard vector and sorts the song IDs in the second list into descending order of similarity. By doing so, songs (i.e., the IDs of songs) in the second list are sorted using the standard vectors to generate a plurality of lists (hereinafter referred to as “third lists”). Also, songs (i.e., the IDs of songs) that resemble the characteristics expressed by the respective standard vectors are disposed at the top of the third lists.

The recommended song list generating unit 207 then extracts the song IDs at the top of the respective third lists and generates a recommended song list including the extracted song IDs. Note that it is desirable to avoid duplication of the song IDs extracted from the respective third lists.

At this time, the number of song IDs extracted from each third list may be set at an equal number or may be set differently for respective third lists. In the latter case, it is desirable to extract a larger number of song IDs from third lists generated using standard vectors that are closer to the taste of the active user.

Note that in the same way as the selection criteria, the number of song IDs extracted from the respective third lists may be set by the service provider based on the result of field tests or the like and/or can be automatically generated by a learning process. Also, the number of song IDs extracted from the third list generated using the standard vector based on the user taste vector may be set higher the larger the amount of taste information accumulated for the active user.

The recommended song list is then generated by listing the song IDs extracted from the respective third lists.

At this time, as one example, it is desirable to arrange the song IDs extracted from the respective third lists so as to be appropriately mixed so that song IDs extracted from the same third list are not excessively consecutive. As one example, it would be conceivable to align the song IDs of the respective third lists so that songs from a different third list appear in turns of every song or every few songs in order from the top. By doing so, this is the equivalent of effectively recommending songs using a plurality of different types of standard vector in turns every song or every few songs.

Note that the order of the third lists from which the song IDs are extracted may be regular or may be irregular. As one example, if song IDs extracted from the third lists A to C are aligned, with the former method, the third lists from which the song IDs are extracted are regularly aligned so that as one example, song IDs of n1 songs are extracted from the third list A, song IDs of n2 songs from the third list B, song IDs of n3 songs from the third list C, song IDs of n4 songs from the third list A, song IDs of n5 songs from the third list B, song IDs of n6 songs from the third list C . . . . Meanwhile with the latter method, the third lists from which the song IDs are extracted are irregularly aligned so that as one example, song IDs of n1 songs are extracted from the third list A, song IDs of n2 songs from the third list B, song IDs of n3 songs from the third list A, song IDs of n4 songs from the third list C, song IDs of n5 songs from the third list B, song IDs of n6 songs from the third list A . . . .

Note that n1 to n6 are natural numbers of one or higher.

Also, the number of consecutive song IDs extracted from the same third list may be set at a constant value or may be changed. As one example, if song IDs of na1 songs in the third list A, song IDs of nb1 songs in the third list B, song IDs of na1 songs in the third list A, and song IDs of nb2 songs in the third list B are aligned in order, na1=na2 and nb1=nb2 may be set, or conversely na1≠na2 and nb1≠nb2 may be set. Also, na1=nb1 and na2=nb2 may be set, and na1≠nb1 or na2≠nb2 may be set.

Note that na1 to nb2 are natural numbers of one or higher.

Also, as necessary, the alignment of songs in the recommended song list may be adjusted so that the gap between songs of the same artist is a specified number of songs or higher. By doing so, it is possible to prevent songs from the same artist from being consecutively reproduced, which would make the list monotonous. Also, if there are restrictions stating that a specified number of songs or more have to be played between songs of the same artist as with Internet radio or the like, it is possible to satisfy such restrictions.

After this, the recommended song list generating process ends.

The description now returns to FIG. 20 and in step S106, the recommended song list generating unit 207 transmits the recommended song list via the transmission/reception unit 101 to the user apparatus 12 of the active user.

A this time, the transmission/reception unit 101 notifies the totaling unit 122 of the song IDs included in the recommended song list, the user ID of the recipient (active user) of the recommended song list, and the client type ID of the user apparatus 12 of the active user. The totaling unit 122 reads the attributes of the active user associated with such user ID from the user attribute database in the user information storage unit 152. The totaling unit 122 then adds one to the distribution frequency x in the total values of the user attribute range to which such combination of attributes and client type of the active user belong in the user attribute-based song evaluation database in the totaled information storage unit 151.

If in step S135, the situation analyzing unit 121 has analyzed the situation of the active user, the situation analyzing unit 121 notifies the totaling unit 122 of the analysis result. After this, in the situation-based song evaluation database in the totaled information storage unit 151, the totaling unit 122 adds one to the distribution frequency x in the total values corresponding to the situation of the active user.

In step S107, the song reproducing unit 62 of the user apparatus 12 receives the recommended song list via the communication network 18 and the communication interface 39.

In step S108, the song reproducing unit 62 requests transmission of song data. More specifically, the song reproducing unit 62 transmits the highest song ID in the order out of the song IDs of songs yet to be reproduced in the recommended song list via the communication interface 39 to the song distributing server 14.

In step S109, the song distributing server 14 sends the song data in reply. More specifically, the distribution unit 125 of the song distributing server 14 receives the song ID transmitted from the user apparatus 12 via the communication network 18 and the transmission/reception unit 101. The distribution unit 125 acquires the song data associated with the received song ID from the song information storage unit 153 and transmits the song data via the transmission/reception unit 101 to the user apparatus 12 that issued the request.

In step S110, the user apparatus 12 reproduces the song data. More specifically, the song reproducing unit 62 of the user apparatus 12 receives the song data transmitted from the song distributing server 14 via the communication network 18 and the communication interface 39. The song reproducing unit 62 then reproduces the received song data.

In step S111, the song reproducing unit 62 determines whether all of the songs included in the recommended song list have been reproduced. If it is determined that not all of the songs included in the recommended song list have been reproduced, the processing returns to step S108.

After this, the processing in steps S108 to S111 is repeatedly carried out until it is determined in step S111 that all of the songs included in the recommended song list have been reproduced. By doing so, songs corresponding to every song ID included in the recommended song list are reproduced in the song order of the list.

Meanwhile, if it is determined in step S111 that every song included in the recommended song list has been reproduced, processing ends.

Note that after every song included in the recommended song list has been reproduced, it is also possible to return to step S101, and start the processing again from step S101.

By carrying out the above processing, it is possible to recommend songs that match the user's taste.

As one example, by providing, to a first-time user, a recommended song list generated using at least one out of three types of default vector in keeping with the attributes of such user, compared to when a recommended song list including songs that are popular on average with all users is provided, it is possible to recommend songs that better match the user's taste. By doing so, the user's satisfaction during the first-time use is improved and the probability of the user continuing to use the service is increased. For the same reasons, the satisfaction of new user with the service is improved until taste information on the user is accumulated.

Also, as described above, by setting the ratio for using or the ratio for combining the user taste vector higher the larger the amount of taste information accumulated for the user, and/or preferentially using a vector that was used with a high frequency or ratio to recommend songs for which the user has provided a positive evaluation, as the number of uses or usage time of the service increases, it is possible to achieve a better match between the recommended songs and the user's taste and thereby improve the user's satisfaction.

In addition, by generating and providing the recommended song list using a situation vector, it is possible to recommend songs in accordance with not only the attributes and/or taste of the user but also the situation in which the user is placed, and thereby improve the user's satisfaction.

Also, by using a plurality of standard vectors in turn and/or using a standard vector produced by combining a plurality of vectors to generate the recommended song list, it is possible to prevent the recommended songs from becoming monotonous, to recommend many songs in keeping with the taste of the user, and to improve the satisfaction of the user.

In addition, since the recommended song list is generated based on various rankings that fluctuate over time, it is possible to prevent having the same songs continuously recommended to the user and to instead recommend many songs to the user.

### 2. Modifications

Modifications to the embodiment of the present disclosure will now be described.

### Modification 1: Instantaneous Reflection of User Evaluation

For example, if the user has provided an evaluation for a song being reproduced, such evaluation may be reflected in real time in the recommended song list.

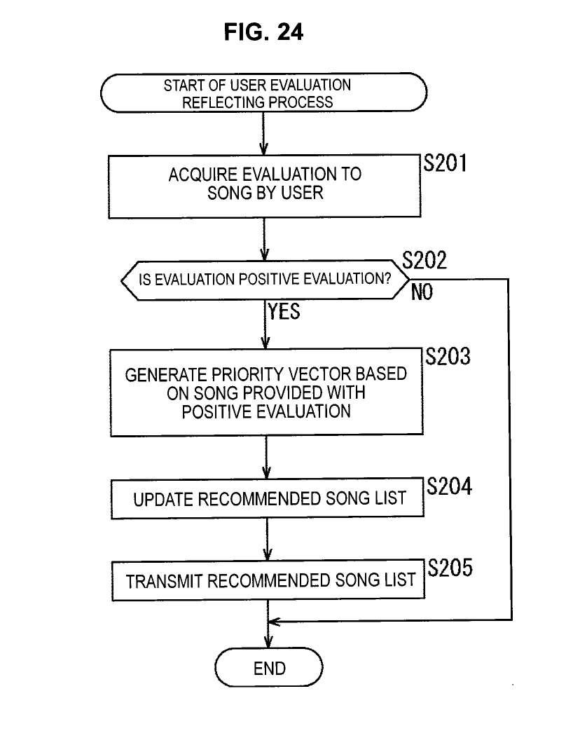

Here, the processing of the song distributing server 14 in a case where a user evaluation is reflected in real time in the recommended song list will be described with reference to FIG. 24.

In step S201, in the same way as the processing in step S1 in FIG. 17, the song distributing server 14 acquires an evaluation (user evaluation information) of a song by the user (active user).

In step S202, the transmission/reception unit 101 determines, based on the received user evaluation information, whether the evaluation is a positive evaluation. When a positive evaluation has been determined, the processing proceeds to step S203.

Note that at this time, as one example determination may be carried out only for positive evaluations clearly provided by the active user, with positive evaluations that are tacitly provided and do not depend on a clear input by the user, such as reproducing a song to the end, being excluded from the determination. That is, the processing proceeds to step S203 only in the former case where a clear positive evaluation has been provided.

In step S203, the priority vector generating unit 134 generates a priority vector based on songs for which positive evaluations have been provided.

More specifically, the transmission/reception unit 101 notifies the priority vector generating unit 134 of the song ID included in the user evaluation information and requests generation of a priority vector. As one example, the priority vector generating unit 134 reads the characteristic values of the notified song ID, that is, the characteristic values of the song provided with a positive evaluation by the active user, from the song evaluation database in the song information storage unit 153. The priority vector generating unit 134 then generates, as a priority vector, a vector that has the read characteristic values as components. That is, in this case, the characteristic vector of the song provided with a positive evaluation by the active user is generated as the priority vector.

As an alternative example, the priority vector generating unit 134 reads characteristic values of a plurality of songs of the artist (for example, representative songs of such artist) of the song provided with a positive evaluation by the active user from the song characteristic database in the song information storage unit 153. At this time, the songs whose characteristic values have been read may include the song provided with a positive evaluation by the active user. After this, the priority vector generating unit 134 may calculate an average value for each characteristic in the characteristic values of the read songs and generate a vector that has the calculated average values as components as a priority vector. That is, in this case, a vector expressing the characteristics of songs of the artist provided with a positive evaluation by the active user is generated as the priority vector.

In step S204, the recommended song list generating unit 207 updates the recommended song list. More specifically, the priority vector generating unit 134 supplies the generated priority vector to the recommended song list generating unit 207 and requests the recommended song list generating unit 207 to update the recommended song list.

As one example, the recommended song list generating unit 207 reads characteristic values associated with the song IDs included in the second list generated by the processing in step S165 described above from the song characteristic database in the song information storage unit 153. After this, the recommended song list generating unit 207 calculates the similarity between characteristic vectors including the characteristic values of song IDs and the priority vector and sorts the song IDs in the second list in descending order of similarity. By doing so, a list (hereinafter referred to as the “priority list”), in which (song IDs of) songs that resemble the characteristics expressed by the priority vector are disposed at the top, is generated.

Also, the recommended song list generating unit 207 deletes song IDs of song data that has already been transmitted to the user apparatus 12 from the updated recommended song list that has been transmitted to the user apparatus 12 of the active user. By doing so, a recommended song list including song IDs that are yet to be transmitted is generated (hereinafter referred to as the “untransmitted recommended song list”).

The recommended song list generating unit 207 then extracts the song ID at the top of the priority list and updates the recommended song list by adding such song ID to the untransmitted recommended song list. At this time, as examples, the song ID extracted from the priority list may be added to the start of the untransmitted recommended song list or the song ID extracted from the priority list and the song IDs in the untransmitted recommended song list may be appropriately mixed.

Note that in the latter case, it is desirable to set the ratio for placing a song ID extracted from the priority list higher, the closer a position in the updated recommended song list is to the start and for such ratio to gradually fall for later positions in the updated recommended song list. By doing so, it is possible to effectively lower the ratio for using the priority vector as time passes from when the active user gave the positive evaluation. As a result, by prioritizing usage of the priority vector immediately after the active user gave the positive evaluation, songs whose characteristics are similar to the song provided with the positive evaluation are recommended with priority, with such priority gradually falling as time passes.

It is also desirable for song IDs to be extracted from the priority list so that song IDs of previously transmitted songs and song IDs of the untransmitted recommended song list are not duplicated.

In addition, the order of songs in the recommended song list after updating may be adjusted as necessary so that the gap between songs of the same artist is a specified number of songs or higher.

In step S205, in the same way as the processing in step S106 in FIG. 20, the recommended song list is transmitted to the user apparatus 12 of the active user. Note that at this time, the total values of the user attribute-based song evaluation database and the situation-based song evaluation database in the totaled information storage unit 151 are updated only for songs that have been extracted from the priority list and newly added to the recommended song list.

After this, the user evaluation reflecting process ends.

Meanwhile, if it is determined in step S202 that the evaluation is not a positive evaluation, the processing in step S203 to S205 is skipped and the user evaluation reflecting process ends.

By doing so, it is possible to quickly reflect a user evaluation to a song in the recommended song list and to recommend, with priority, songs whose characteristics are similar to the song provided with the positive evaluation by the user. By doing so, it is possible to quickly respond to user likes and to improve the user's satisfaction.

Note that as one example, if a negative evaluation has been given by the active user, songs whose characteristics are similar to the song provided with the negative evaluation by the user may be deleted from the recommended song list.

### Modification 2: Modification to Types of Vectors

The types of vectors provided earlier are mere examples and it is also possible to use other types of vectors as standard vectors or to use other types of vectors to generate the standard vectors.

As one example, vectors based on songs liked by famous artists (hereinafter referred to as “artist vectors”) may be generated and used. By doing so, respective users are capable of using the vectors of artists liked by such users to receive recommendations of songs liked by such artists.

It is also possible to carry out clustering of users into a plurality of clusters based on taste information and to generate and use vectors (hereinafter referred to as “cluster vectors”) for each cluster. As one example, in the same way as for the default vectors described earlier, it is possible to extract popular songs of users in a cluster and generate a cluster vector based on the characteristic values of the extracted popular songs.

Note that as the method of clustering users, it is possible to use the method disclosed in Japanese Laid-Open Patent Publication No. 2011-257917 or another arbitrary method.

### Modification 3: Modification to Method of Setting Standard Vectors

Although an example where the song distributing server 14 automatically sets the standard vectors is described in the above description, as another example it is possible for the user to select the vectors to be used as the standard vectors. As another example, if the recommended song list is generated using a plurality of standard vectors, it may be possible for the user to set the ratios with which respective vectors will be used. In addition, if the recommended song list is generated by combining a plurality of vectors, it may be possible for the user to set the ratios for combining the respective vectors.

### Modification 4: Modification to Method of Extracting Recommended Songs

Although an example where recommended songs are extracted based on rankings of songs is described in the above example, it is also possible to extract songs according to another method.

For example, songs may be extracted randomly or songs whose characteristic vectors are similar to the standard vector may be extracted. In the latter case, as one example, it is possible to generate a recommended song list including songs that are very similar and provide such list to the user.

Also, the present disclosure may also be applied to simply extracting songs whose characteristic vectors are similar to the standard vector without generating a recommended song list, and recommending such songs to the user.

In addition, as another example, by using an inverse vector to the standard vector, it is possible to dispose songs whose characteristic vectors resemble the inverse vector at the bottom of the recommended song list or to remove such songs from the recommended song list.

Modification 5: Modification to Criteria for Regions when Generating Region-Based Vectors

Various criteria can be set as the criteria for regions when generating region-based vectors, as examples, countries, regions including a plurality of countries such as North America and the EU (European Union), or regions within countries such as states or prefectures.

### Modification 6: Modification to Dividing-Up of Processing

For example, as one example, each user apparatus 12 may acquire the characteristic vector of each song from the song distributing server 14 and generate the user taste vector at the user apparatus 12. As one example, the user apparatus 12 may then include the user taste vector in a song list request and send such song list request to the song distributing server 14.

As one example, it is also possible to provide an indicated characteristic vector generated by another apparatus to the song distributing server 14 without having each vector generated at the song distributing server 14.

In addition, a mechanism for analyzing the characteristic values of a song may be provided in the song distributing server 14.

### Modification 7: Modification to Content

Also, the present disclosure can be applied to a case where various types of content are recommended, such as video like a movie or a television program, a still image such as a photograph or a painting, an electronic book, game, or a document file.

Also, the characteristic values for the content in use may be changed as appropriate according to the type of content.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

It should be noted that the program executed by a computer may be a program that is processed in time series according to the sequence described in this specification or a program that is processed in parallel or at necessary timing such as upon calling.

Further, in the present disclosure, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

It should be understood by those skilled in the art that various modifications, combinations, sub-combinations and alterations may occur depending on design requirements and other factors insofar as they are within the scope of the appended claims or the equivalents thereof.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Additionally, the present technology may also be configured as below.

(1) An information processing apparatus including:

a totaling unit gathering information indicating a client type of a client used by a user who makes use of a service recommending content and taste information indicating an evaluation to content provided by the user and totaling the evaluation to content provided by the user according to the client type;

a vector generating unit generating at least a user taste vector expressing a characteristic of content liked by the user and a client type-based vector expressing the characteristic of content liked by the user on a client-type basis; and

a recommending unit recommending content by using at least one of the vectors generated by the vector generating unit and a characteristic vector expressing a characteristic of content and, recommending content to a first-time user who makes use of the service for a first time by using the client type-based vector corresponding to the client type of a client used by the first-time user.

(2) The information processing apparatus according to (1),

wherein the totaling unit further gathers information showing a region to which a user belongs and totals an evaluation to content given by the user on a region basis,

wherein the vector generating unit further generates a region-based vector expressing the characteristic of content liked by the user on a region basis, and

wherein the recommending unit recommends content to the first-time user by further using the region-based vector corresponding a region to which the first-time user belongs.

(3) The information processing apparatus according to (1) or (2),

wherein the totaling unit further gathers information showing an age of a user and totals an evaluation to content by the user on an age basis or on an age bracket basis,

wherein the vector generating unit further generates an age-based vector expressing the characteristic of content liked by the user on an age basis or on an age-bracket basis, and

wherein the recommending unit recommends content to the first-time user by further using the age-based vector corresponding to an age of the first-time user.

(4) The information processing apparatus according to any one of (1) to (3),

wherein the recommending unit recommends content by alternately using a plurality of types of vectors generated by the vector generating unit.

(5) The information processing apparatus according to (4),

wherein the vector generating unit is operable, when a user provides a positive evaluation to content, to generate a priority vector expressing a characteristic of the content or a characteristic of an artist of the content, and

wherein the recommending unit recommends content to the user by preferentially using the priority vector.

(6) The information processing apparatus according to (5),

wherein the recommending unit reduces a ratio at which the priority vector is used with an elapse of time since the user has provided the positive evaluation to the content.

(7) The information processing apparatus according to any one of (4) to (6),

wherein, as a user has a larger amount of the taste information accumulated, the recommending unit increases a ratio at which the user taste vector of the user is used.

(8) The information processing apparatus according to any one of (4) to (7),

wherein the recommending unit recommends content to a user by preferentially using a vector that has been used with a high frequency or at a high ratio for recommending content to which the user has provided a positive evaluation.

(9) The information processing apparatus according to any one of (1) to (8),

wherein the recommending unit recommends content by using a vector produced by combining a plurality of types of vector generated by the vector generating unit.

(10) The information processing apparatus according to (9),

wherein, as a user has a larger amount of the taste information accumulated, the recommending unit increases a ratio at which the user taste vector of the user is combined.

(11) The information processing apparatus according to any one of (1) to (10), further including:

a situation analyzing unit analyzing, based on position information transmitted from a client, a situation of a user using the client,

wherein the totaling unit totals an evaluation to content by the user in the situation, and

wherein the vector generating unit further generates a situation vector expressing the characteristic of content liked by the user on a situation basis.

(12) An information processing method carried out by an information processing apparatus providing a service that recommends content, the method including:

gathering information indicating a client type of a client used by a user who makes use of the service and taste information indicating an evaluation to content provided by the user and totaling the evaluation to content provided by the user according to the client type;

generating at least a user taste vector expressing a characteristic of content liked by the user and a client type-based vector expressing the characteristic of content liked by the user on a client-type basis; and

recommending content by using at least one of the vectors generated by the vector generating unit and a characteristic vector expressing a characteristic of content and, recommending content to a first-time user who makes use of the service for a first time by using the client type-based vector corresponding to the client type of a client used by the first-time user.

(13) A program for causing a computer to execute:

gathering information indicating a client type of a client used by a user who makes use of a service recommending content and taste information indicating an evaluation to content provided by the user and totaling the evaluation to content by the user according to the client type;

generating at least a user taste vector expressing a characteristic of content liked by the user and a client type-based vector expressing the characteristic of content liked by the user on a client-type basis; and

recommending content by using at least one of vectors generated by a vector generating unit and a characteristic vector expressing a characteristic of content and, recommending content to a first-time user who makes use of the service for a first time by using the client type-based vector corresponding to the client type of a client used by the first-time user.

The present disclosure contains subject matter related to that disclosed in Japanese Priority Patent Application JP 2012-132877 filed in the Japan Patent Office on Jun. 12, 2012, the entire content of which is hereby incorporated by reference.

What is claimed is:

1. An information processing apparatus comprising:
a totaling unit gathering information indicating a client type of a client used by a user who makes use of a service recommending content and taste information indicating an evaluation to content provided by the user and totaling the evaluation to content provided by the user according to the client type;
a vector generating unit generating at least a user taste vector expressing a characteristic of content liked by the user and a client type-based vector expressing the characteristic of content liked by the user on a client-type basis; and
a recommending unit recommending content by using at least one of the vectors generated by the vector generating unit and a characteristic vector expressing a characteristic of content and, recommending content to a first-time user who makes use of the service for a first time by using the client type-based vector corresponding to the client type of a client used by the first-time user.

2. The information processing apparatus according to claim 1,
wherein the totaling unit further gathers information showing a region to which a user belongs and totals an evaluation to content given by the user on a region basis,
wherein the vector generating unit further generates a region-based vector expressing the characteristic of content liked by the user on a region basis, and
wherein the recommending unit recommends content to the first-time user by further using the region-based vector corresponding a region to which the first-time user belongs.

3. The information processing apparatus according to claim 1,
wherein the totaling unit further gathers information showing an age of a user and totals an evaluation to content by the user on an age basis or on an age bracket basis,
wherein the vector generating unit further generates an age-based vector expressing the characteristic of content liked by the user on an age basis or on an age-bracket basis, and
wherein the recommending unit recommends content to the first-time user by further using the age-based vector corresponding to an age of the first-time user.

4. The information processing apparatus according to claim 1,
wherein the recommending unit recommends content by alternately using a plurality of types of vectors generated by the vector generating unit.

5. The information processing apparatus according to claim 4,
wherein the vector generating unit is operable, when a user provides a positive evaluation to content, to generate a priority vector expressing a characteristic of the content or a characteristic of an artist of the content, and
wherein the recommending unit recommends content to the user by preferentially using the priority vector.

6. The information processing apparatus according to claim 5,
wherein the recommending unit reduces a ratio at which the priority vector is used with an elapse of time since the user has provided the positive evaluation to the content.

7. The information processing apparatus according to claim 4,
wherein, as a user has a larger amount of the taste information accumulated, the recommending unit increases a ratio at which the user taste vector of the user is used.

8. The information processing apparatus according to claim 4,
wherein the recommending unit recommends content to a user by preferentially using a vector that has been used with a high frequency or at a high ratio for recommending content to which the user has provided a positive evaluation.

9. The information processing apparatus according to claim 1,
wherein the recommending unit recommends content by using a vector produced by combining a plurality of types of vector generated by the vector generating unit.

10. The information processing apparatus according to claim 9,
wherein, as a user has a larger amount of the taste information accumulated, the recommending unit increases a ratio at which the user taste vector of the user is combined.

11. The information processing apparatus according to claim 1, further comprising:
a situation analyzing unit analyzing, based on position information transmitted from a client, a situation of a user using the client,
wherein the totaling unit totals an evaluation to content by the user in the situation, and
wherein the vector generating unit further generates a situation vector expressing the characteristic of content liked by the user on a situation basis.

12. An information processing method carried out by an information processing apparatus providing a service that recommends content, the method comprising:
gathering information indicating a client type of a client used by a user who makes use of the service and taste information indicating an evaluation to content provided by the user and totaling the evaluation to content provided by the user according to the client type;
generating at least a user taste vector expressing a characteristic of content liked by the user and a client type-based vector expressing the characteristic of content liked by the user on a client-type basis; and
recommending content by using at least one of the vectors generated by the vector generating unit and a characteristic vector expressing a characteristic of content and, recommending content to a first-time user who makes use of the service for a first time by using the client type-based vector corresponding to the client type of a client used by the first-time user.

13. A program for causing a computer to execute:
gathering information indicating a client type of a client used by a user who makes use of a service recommending content and taste information indicating an evaluation to content provided by the user and totaling the evaluation to content by the user according to the client type;
generating at least a user taste vector expressing a characteristic of content liked by the user and a client type-based vector expressing the characteristic of content liked by the user on a client-type basis; and
recommending content by using at least one of vectors generated by a vector generating unit and a characteristic vector expressing a characteristic of content and, recommending content to a first-time user who makes use of the service for a first time by using the client type-based vector corresponding to the client type of a client used by the first-time user.
